(19) United States
(12) Patent Application Publication
(10) Pub. No.: US 2013/0279375 A1
(43) Pub. Date: Oct. 24, 2013

(54) METHOD AND APPARATUS FOR ENABLING INTEROPERABILITY BETWEEN A BROADBAND NETWORK AND A NARROWBAND NETWORK

(71) Applicants: Donald G. Newberg, Hoffman Estates, IL (US); Michelle M. Antonelli, Barrington, IL (US); Peter M. Drozt, Prairie Grove, IL (US); Michael F. Korus, Eden Prairie, MN (US)

(72) Inventors: Donald G. Newberg, Hoffman Estates, IL (US); Michelle M. Antonelli, Barrington, IL (US); Peter M. Drozt, Prairie Grove, IL (US); Michael F. Korus, Eden Prairie, MN (US)

(73) Assignee: MOTOROLA SOLUTIONS, INC., SCHAUMBURG, IL (US)

(21) Appl. No.: 13/452,590

(22) Filed: Apr. 20, 2012

(51) Int. Cl. H04W 72/04; H04W 4/06; H04W 4/16; H04W 60/00

(52) U.S. Cl. 370/260; 370/329; 370/312

(57) ABSTRACT

A method and apparatus for enabling interoperability between a broadband network and a narrowband network includes an interworking server maintaining at least one virtual narrowband site, each comprising a plurality of virtual narrowband channels known by a controlling server within the narrowband network, wherein each virtual narrowband channel, when assigned by the controlling server, represents a corresponding set of broadband resources. A first broadband device coupled to the broadband network is associated with a first virtual narrowband site. The interworking server further exchanges signaling with the controlling server to enable communications by the first broadband device using a set of broadband resources corresponding to a first virtual narrowband channel of the first virtual narrowband site, wherein the first virtual narrowband channel is assigned by the controlling server for use by a virtual narrowband device which represents the first broadband device.

### FIELD OF THE DISCLOSURE

The present disclosure relates generally to wireless communications and more particularly to methods and apparatus for enabling interoperability between a broadband network and a narrowband network.

### BACKGROUND

Since its inception in the 1920s, Land Mobile Radio (LMR) has established itself as the dominant form of wireless communication for a vast variety of federal, state/province and local Public Safety agencies. Its centralized command and control structure made it an ideal platform for dedicated mission-critical operation, which continued to evolve over the following decades. Advances in digital radio technology during the 1990s, for example, allowed LMR networks to grow beyond the limitations imposed by analog transmission. The 1990s also saw efforts to achieve interoperability between LMR networks by standardizing the varying protocols and radio spectrum used between them, resulting in a suite of standards called Project 25 (also known in the art as P25 or APCO-25), which allowed for communication between different agencies operating on disparate networks.

The tragedy of 9/11 exposed shortcomings of Public Safety LMR in dealing with large-scale disasters; shortcomings that were again demonstrated in 2005 when hurricanes Katrina and Rita struck the Gulf Coast. This led the FCC (Federal Communications Commission) to adopt rules in 2007 to promote the construction of a nationwide seamless Public Safety broadband network that would operate in the 700 MHz spectral band. Advantages gained through the use of a national Public Safety broadband system are numerous, and include, for instance: increased bandwidth for image and video transmission, voice over Internet Protocol (IP) capability, remote database access, text messaging and e-mail, continued operation during infrastructure failures, automatic unit and vehicle location, non-local accessibility, web access, improved security, computer-aided dispatching, etc.

The eventual migration of Public Safety communications to a broadband-based system will take place over a period of many years as the relevant technology and infrastructure becomes reliable and ubiquitous. In the interim, narrowband users may prefer to leverage their pre-existing narrowband equipment for communication over broadband systems.

Accordingly, there is a need for enabling interoperability between a broadband network and a narrowband network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a communication system having a broadband network and a narrowband network in accordance with an embodiment of the present teachings.

FIG. 2 is a logical flowchart illustrating general functionality of an interworking server within the communication system of FIG. 1 for enabling interoperability between the broadband and narrowband networks in accordance with some embodiments of the present teachings.

FIG. 3 is a block diagram providing further details of elements within the communication system of FIG. 1 in accordance with an embodiment of the present teachings.

FIG. 4 is a message sequence diagram illustrating messaging between elements of the communication system shown in FIG. 3 for enabling interoperability between the broadband and narrowband networks in accordance with some embodiments of the present teachings.

FIG. 5 is a message sequence diagram illustrating messaging between elements of the communication system shown in FIG. 3 for enabling interoperability between the broadband and narrowband networks in accordance with some embodiments of the present teachings.

FIG. 6 is a message sequence diagram illustrating messaging between elements of the communication system shown in FIG. 3 for enabling interoperability between the broadband and narrowband networks in accordance with some embodiments of the present teachings.

FIG. 7 is a message sequence diagram illustrating messaging between elements of the communication system shown in FIG. 3 for enabling interoperability between the broadband and narrowband networks in accordance with some embodiments of the present teachings.

FIG. 8 is a message sequence diagram illustrating messaging between elements of the communication system shown in FIG. 3 for enabling interoperability between the broadband and narrowband networks in accordance with some embodiments of the present teachings.

FIG. 9 is a message sequence diagram illustrating messaging between elements of the communication system shown in FIG. 3 for enabling interoperability between the broadband and narrowband networks in accordance with some embodiments of the present teachings.

FIG. 10 is a message sequence diagram illustrating messaging between elements of the communication system shown in FIG. 3 for enabling interoperability between the broadband and narrowband networks in accordance with some embodiments of the present teachings.

FIG. 11 illustrates a communication system having a broadband and a narrowband network in accordance with another embodiment of the present teachings.

FIG. 12 is a block diagram illustrating assignment of virtual narrowband channels and assignment of corresponding broadband resources in accordance with an embodiment of the present teachings.

FIG. 13 is a block diagram illustrating assignment of virtual narrowband channels and assignment of corresponding broadband resources in accordance with another embodiment of the present teachings.

FIG. 14 is a logical flowchart illustrating a method for associating a broadband device to a virtual narrowband site for enabling the broadband device to communicate with a narrowband communication group while coupled to the broadband network in accordance with an embodiment of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for enabling interoperability between a broadband network and a narrowband network. In accordance with the teachings herein, a method performed by an interworking server for enabling interoperability between a broadband network and a narrowband network includes maintaining at least one virtual narrowband site, each site comprising a plurality of virtual narrowband channels known by a controlling server within the narrowband network, wherein each virtual narrowband channel, when assigned by the controlling server, represents a corresponding set of broadband resources, wherein a first broadband device coupled to the broadband network is associated with a first virtual narrowband site. The method further includes the interworking server exchanging signaling with the controlling server to enable communications by the first broadband device using a first set of broadband resources corresponding to a first virtual narrowband channel of the first virtual narrowband site, wherein the first virtual narrowband channel is assigned by the controlling server for use by a first virtual narrowband device which represents the first broadband device.

Further in accordance with the teachings herein, an apparatus for enabling interoperability between a broadband network and a narrowband network includes a processing device configured to maintain a set of virtual narrowband sites, each virtual narrowband site comprising a plurality of virtual narrowband channels known by a controlling server within the narrowband network. The apparatus further includes a first interface configured to receive from the controlling server an assignment of a first virtual narrowband channel from the plurality of virtual narrowband channels of a first virtual narrowband site of the set of virtual narrowband sites, wherein the assignment is for a first group communication session for a first narrowband communication group to which a first virtual narrowband device is joined, wherein the first virtual narrowband device represents a first broadband device coupled to the broadband network and is associated with the first virtual narrowband site, wherein the processing device is further configured to determine a first broadband resource corresponding to the first virtual narrowband channel. The apparatus also includes a second interface configured to provide to the first broadband device an indication of the first broadband resource for the first broadband device to at least one of send or receive a media stream for the first group communication session.

Also in accordance with the teachings herein, is a non-transient computer-readable storage element having computer-readable code stored thereon for programming a computer to perform a method for enabling interoperability between a broadband network and a narrowband network. The method includes maintaining at least one virtual narrowband site, each comprising a plurality of virtual narrowband channels known by a controlling server within the narrowband network, wherein each virtual narrowband channel, when assigned by the controlling server, represents a corresponding set of broadband resources, wherein a first broadband device coupled to the broadband network is associated with a first virtual narrowband site. The method further includes exchanging signaling with the controlling server to enable communications by the first broadband device using a first set of broadband resources corresponding to a first virtual narrowband channel of the first virtual narrowband site, wherein the first virtual narrowband channel is assigned by the controlling server for use by a first virtual narrowband device which represents the first broadband device.

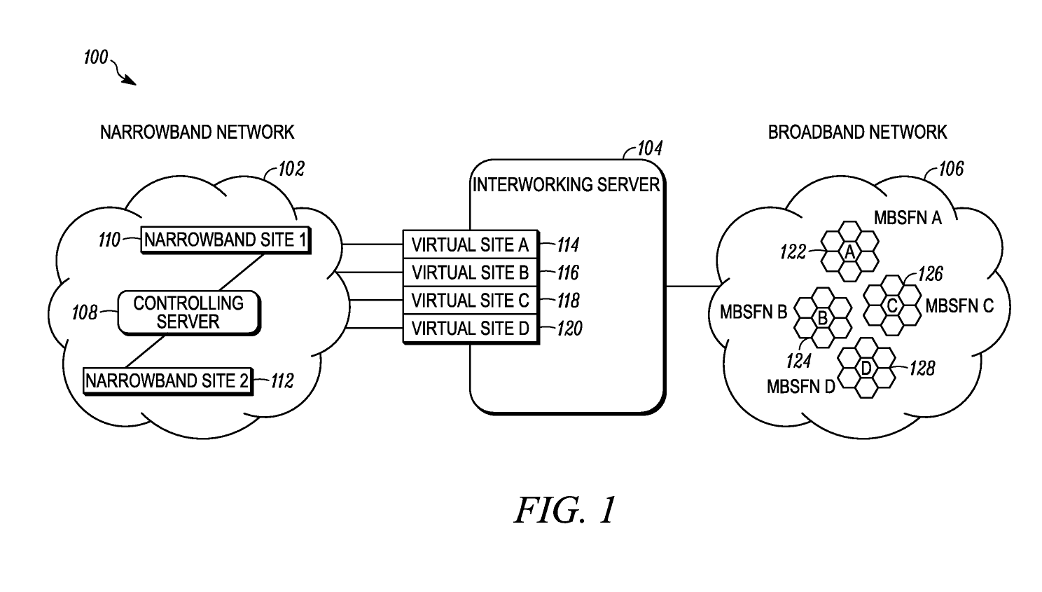

Referring now to the drawings, and in particular FIG. 1, a communication system implementing embodiments in accordance with the present teachings is shown and indicated generally at 100. System 100 comprises: a narrowband network 102 having a controlling server 108 and two narrowband sites 110 and 112; an interworking server 104; and a broadband network 106, which in this example implementation is a Multimedia Broadcast/Multicast Service (MBMS)-enabled broadband network. Only a limited number of system elements 102, 104, 106, 108, 110, and 112 are shown for ease of illustration, but additional such elements may be included in the communication system 100. Moreover, other components needed for a commercial embodiment of the system 100 are omitted from the drawing for clarity in describing the disclosed embodiments.

Generally speaking, pursuant to the present teachings, the interworking server 104 is configured (i.e., adapted) to facilitate interoperability between the narrowband network 102 and the broadband network 106. For example, signaling between the interworking server 104 and the controlling server 108 enables or facilitates participation within a narrowband communication group by communication devices coupled (i.e., operatively coupled or communicatively coupled) to the broadband network 106 and using broadband resources.

As used herein, a “communication group” (also referred to herein simply as a “group”) has a plurality of members that are authorized to engage in mutual communication with each other while being joined to an active communication session associated with the group. A communication group wherein voice media is communicated between the members is known as a talkgroup, but communication groups can be created to communicate any type of media between its members. A “narrowband communication group” is any communication group wherein membership, participation and/or resources for the group are managed, at least in part, by one or more elements within a narrowband network, such as the controlling server 108.

Furthermore, a narrowband communication device (or “narrowband device”) is a communication device having the hardware, software and/or firmware needed to operatively couple to and communicate using a narrowband network. A broadband communication device (or “broadband device”) is a communication device having the hardware, software and/or firmware needed to operatively couple to and communicate using a broadband network. It is understood that both a narrowband device and a broadband device can share the same physical housing and operate as either a narrowband device or a broadband device at any given point in time, as relates to the teachings herein.

Moreover, as used herein, a communication device being operatively or communicatively coupled (or simply coupled) to a broadband or narrowband network means that the communication device has exchanged the necessary signaling with the network to send or receive information or communications (e.g., media) using the network. For example, a broadband device in an idle state and receiving MBMS point-to-multipoint transmissions is considered coupled to a broadband network, as well as a broadband device that has successfully exchanged signaling with the broadband network using the Radio Resource Control (RRC) protocol specified in 3GPP TS 25.331.

We now turn to a detailed description of the system elements within communication system 100. In general, infrastructure elements within the narrowband network 102 (including the controlling server 108 and infrastructure elements within the narrowband sites 110 and 112), the interworking server 104, infrastructure elements within the broadband network 106, and the communication devices are all adapted or configured with hardware, software, and/or firmware to perform their particular functionality, including functionality in accordance with embodiments of the present disclosure, for example, as described in detail below with respect to the remaining figures. Being “adapted” or “configured” means that such elements are implemented using one or more (although not shown) memory devices, interfaces, and/or processing devices that are operatively coupled. The memory devices, interfaces, and/or processing devices (also generally referred to herein as a computer), when programmed, form the means for these system elements and communication devices to implement their desired functionality.

Interfaces are used for exchanging signaling, also referred to herein as messaging (e.g., messages, packets, datagrams, frames, superframes, and the like), containing control information, voice, or non-voice media between the elements of system 100. A particular interface of any system element or communication device might be wired or wireless depending on the other device(s) to which the interface connects. For example, the interworking server 104 may have both a wired interface to communicate with (i.e., communicatively connect or communicatively couple to) infrastructure elements within the narrowband network 102 and a wireless interface to communicate with infrastructure elements within the broadband network 106. Examples of wired interfaces include, but are not limited to, Ethernet, T1, USB interfaces, etc.

Where system elements or communication devices use wireless signaling, the interfaces comprise components including processing, modulating and transceiver components that are operable in accordance with any one or more standard or proprietary wireless interfaces, supporting, for instance, LTE (Long Term Evolution), WiFi, etc. Some of the functionality of the processing, modulating and transceiver components may be performed by means of a processing device, through programmed logic such as software applications or firmware stored on the memory device of the system element, or through hardware.

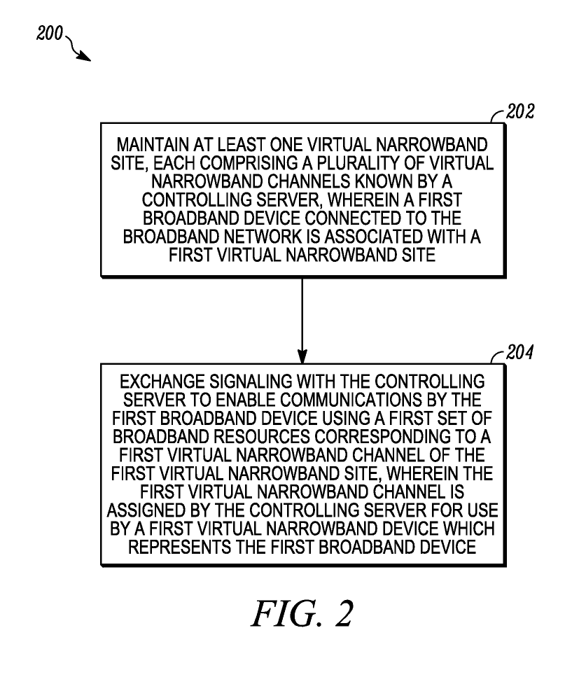

The processing devices utilized by the elements of system 100 and the communication devices using system 100 may be partially implemented in hardware and, thereby, programmed with software or firmware logic or code for performing functionality described by reference to FIGS. 2-14; and/or the processing devices may be completely implemented in hardware, for example, as a state machine or ASIC (application specific integrated circuit). The type of memory implemented can include short-term and/or long-term memory to store information needed for the functioning of the respective elements. The memory may further store software and/or firmware for programming the processing device with the logic or code needed to perform its functionality.

The narrowband network 102 can be a trunked or a combined trunked and conventional network but is any type of network that assigns only “narrowband channels” for communication devices to use in transmitting and/or receiving (i.e., communicating) media. A narrowband channel is a channel or communication resource used to send messages, wherein the bandwidth is sufficiently narrow such that only one media stream is transported on the channel at any given time. In one illustrative implementation, a narrowband channel has a bandwidth of 25 kHz or less. In a particular embodiment, the narrowband network 102 comprises, for example, one or more Project 25 or Terrestrial Trunked Radio (TETRA) Land Mobile Radio (LMR) communication systems.

Within narrowband network 102, each narrowband site (e.g., 110 and 112) comprises or has associated therewith a set of narrowband channels, which are the narrowband resources for the narrowband site. One or more of these narrowband channels can be dedicated for sending control information (i.e., control channels). The controlling server 108 within the narrowband network 102 manages the narrowband resources of the narrowband sites by assigning narrowband channels to facilitate communications between narrowband communication devices (e.g., used by group members) that are registered to the narrowband network 102 and located at and communicatively coupled to the sites.

The broadband network 106 is any type of network that can assign “broadband channels” for communication devices to use in communicating media. By contrast to a narrowband channel, a broadband channel (also sometimes referred to in the art as a “wideband” channel) is a channel or communication resource used to send messages, wherein the bandwidth is sufficiently broad to enable multiple media streams to share a single broadband channel. In one illustrative implementation, a broadband channel has a bandwidth of greater than 1 MHz (supporting data rates of greater than about 1.5 Mbits/s).

As mentioned earlier, the broadband network 106 is an MBMS-enabled communication network having infrastructure elements that are configured to provide MBMS service as specified in multiple 3rd Generation Partnership Project (3GPP) Technical Specifications (TSs), e.g., 3GPP TS 22.246 and 26.346. However, broadband network 106 can be any point-to-point and/or point-to-multipoint enabled communication network, including a network that uses unicast transports, multicast transports, broadcast transports, or any combination thereof. Moreover, the teachings herein are applicable to any broadband network having a core network and a Radio Access Network (RAN) that is adapted to be interoperably coupled to a narrowband network as taught herein. For example, the present teachings are also applicable to a communication system 100 having a Long Term Evolution (LTE) broadband network (where at least some of its elements are configured to operate in conformity with one or more aspects of 3GPP LTE TSs), a 3GPP2 network, or a Worldwide Interoperability for Microwave Access (WiMAX) network, for example.

Shown within the broadband network 106 are multiple broadband areas, which in this case are four Multimedia Broadcast over a Single Frequency Network (MBSFN) areas 122 (A), 124 (B), 126 (C) and 128 (D). A broadband area, as used herein, represents a geographic region within the entire broadband network. Although the example implementation described herein bases the geographical partitioning of the broadband areas (e.g., the MBSFN areas) on synchronized point-to-multipoint transmissions, the partitioning for broadband areas, in general, is not so limited. As described in the 3GPP TSs, a RAN, such as an LTE Evolved Universal Mobile Telecommunications System Terrestrial Radio Access Network (E-UTRAN), can be partitioned into one or more MBSFN areas, identified by MBSFN area IDs, with each MBSFN area covering a particular geographical region in which a synchronized MBMS transmission can occur. MBMS transmissions are synchronized across eNodeBs within each MBSFN so that all MBMS-capable broadband devices within a given MBSFN's coverage area can receive the identical transmission.

Each MBSFN area of FIG. 1 includes a plurality of cells, identified by cell identifiers, which define its coverage area. Moreover, each MBSFN area is shown as a collection of seven hexagons, with each hexagon representing one or more (typically three) cells of an eNodeB that can participate in the synchronized point-to-multipoint transmissions for the MBSFN area. While the overall shape of each MBSFN area within FIG. 1 is uniform and non-overlapping, this is only illustrative and does not limit an actual MBSFN area implementation. In practice, MBSFN areas, which can comprise any number of cells, may (and typically do) differ in size and/or shape; and one or more such areas may overlap in coverage area, in a practical implementation. It should be noted that the present teachings are also applicable where the broadband network 106 does not provide MBMS services, as explained in detail below.

The interworking server 104 manages (e.g., has provisioned thereon) one or more virtual narrowband sites (also referred to herein as virtual sites). In the example implementation shown in FIG. 1, the interworking server 104 manages four virtual sites 114-120 but may be provisioned with more or fewer such sites. A virtual narrowband site is defined herein as a logical grouping of data (e.g., a site ID, a plurality of channel IDs and/or channel frequencies, etc.) maintained by an interworking server and presented to a controlling server as an actual physical narrowband site. As such, each virtual narrowband site has associated therewith a plurality of virtual narrowband channels, again presented to the controlling server 104 as actual narrowband channels, which the controlling server 104 is allowed to manage in accordance with the present teachings. The virtual narrowband channels are, for instance, identified using channel identifiers and/or channel frequencies that are compatible with those used in a narrowband network to identify actual narrowband channels.

In one example implementation, MBSFN areas 122-128 within the broadband network 106 are associated with (i.e., mapped to) corresponding virtual narrowband sites 114-120 provisioned on the interworking server 104. As shown, each MBSFN area 122-128 corresponds to exactly one virtual narrowband site, as indicated by the letter designations “A” through “D.” Moreover, in one particular embodiment, each virtual site has mapped thereto a plurality of pre-allocated MBMS bearers from the corresponding MBSFN area, which serve as the plurality of virtual narrowband channels for the virtual site.

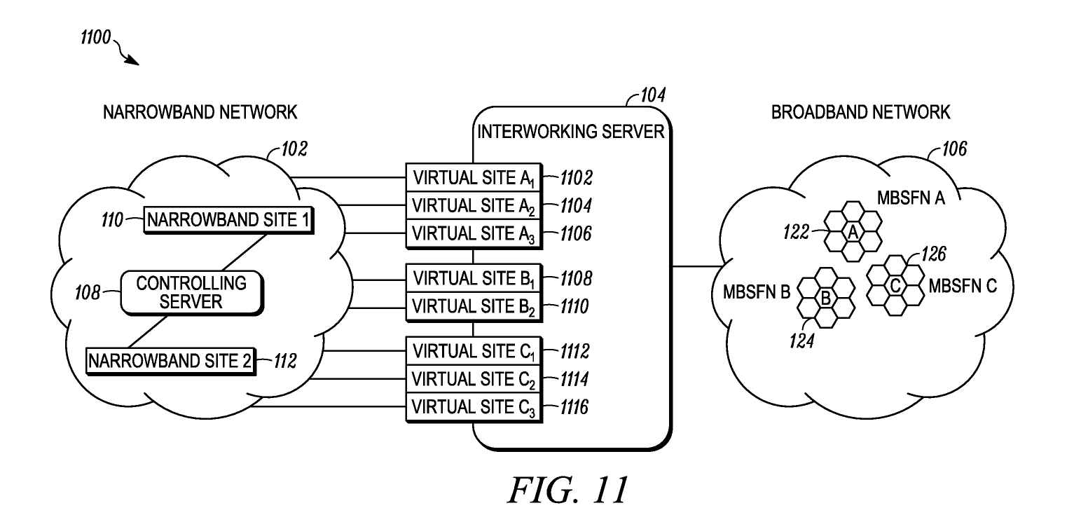

For example, virtual narrowband site A is mapped to MBSFN area A, wherein virtual narrowband site A comprises a plurality of virtual narrowband channels mapped to a plurality of MBMS bearers that are pre-allocated from MBSFN area A. Alternate embodiments, however, allow for the mapping of multiple MBSFN areas to the same virtual narrowband site, or the mapping of a single MBSFN area to multiple virtual narrowband sites, as indicated below with respect to FIG. 11. Moreover, virtual narrowband sites need not be mapped to MBSFN areas, and in other example implementations, can be mapped to broad geographical areas, tracking areas, or specific sets of broadband devices, such as those without access to MBMS service.

This “mapping” can be simply a matrix or a table stored on the interworking server 104 associating each narrowband site with a corresponding broadband area and (in some embodiments) identifying a plurality of broadband resources that are pre-allocated from the broadband area. In the example implementation mentioned above, a plurality of pre-allocated point-to-multipoint (e.g., MBMS) bearers is mapped to the plurality of virtual narrowband channels for a virtual site. “Pre-allocated,” as used herein, means that the bearer for a virtual site is established a priori and held in reserve until needed for an active communication session involving a broadband device associated with the virtual site. Such an implementation utilizing pre-allocated broadband resources mapped to virtual narrowband channels allows the controlling server 108 to directly manage broadband resources for an active communication session by managing the virtual narrowband channels of a given virtual site. In another example implementation, pre-allocated point-to-point resources are mapped to one or more of the virtual narrowband channels to allow the controlling server 108 to directly manage the broadband resources for an active communication session.

However, in yet another example implementation, upon selection by the controlling server 108 of a virtual narrowband channel, one or more point-to-point bearers and/or or point-to-multipoint bearers are dynamically allocated (i.e., established for use by one or more broadband devices) “on-the-fly” or as needed for a communication session. This alternative implementation allows the controlling server 108 to indirectly manage broadband resources by triggering the interworking server 104 to dynamically establish the broadband resources as needed. Accordingly, embodiments herein support the use of pre-allocated point-to-point broadband resources, dynamically established point-to-point broadband resources, pre-allocated point-to-multipoint broadband resources, dynamically established point-to-multipoint broadband resources, or any combination thereof, mapped to virtual narrowband channels.

We turn now to a detailed description of the functionality of the system 100 elements in accordance with the teachings herein and by reference to the remaining figures. FIG. 2 shows a logical flowchart 200 illustrating general functionality of the interworking server 104 in accordance with an embodiment of the present disclosure. At 202, an interworking server (e.g., 104) maintains at least one virtual narrowband site, each comprising a plurality of virtual narrowband channels known by a controlling server (e.g., 108). In an embodiment, the controlling server 108 “knows” the virtual narrowband channels for each virtual narrowband site by being provisioned or programmed with such data (e.g., channel IDs and/or frequencies) that represents the virtual narrowband channels. This provisioning is performed by a narrowband system administrator, the interworking server 104, etc. In accordance with the present teachings, each virtual narrowband channel, when assigned by the controlling server 108, represents a corresponding set of broadband resources allocated within the broadband network 106, as explained in more detail below.

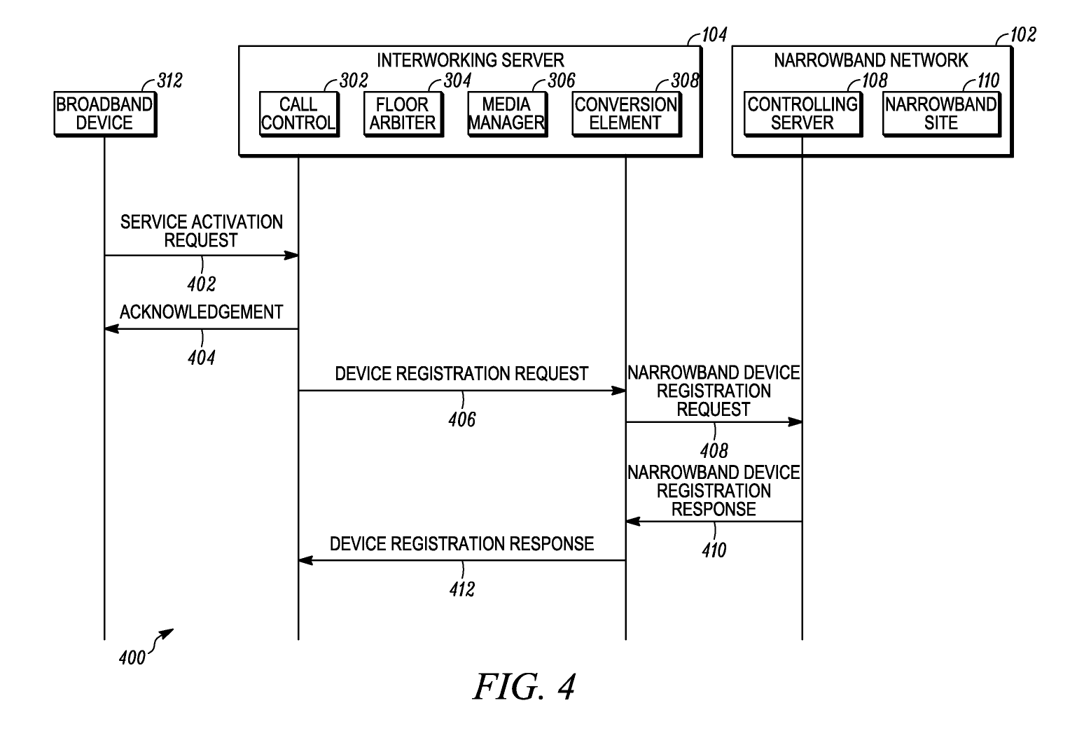

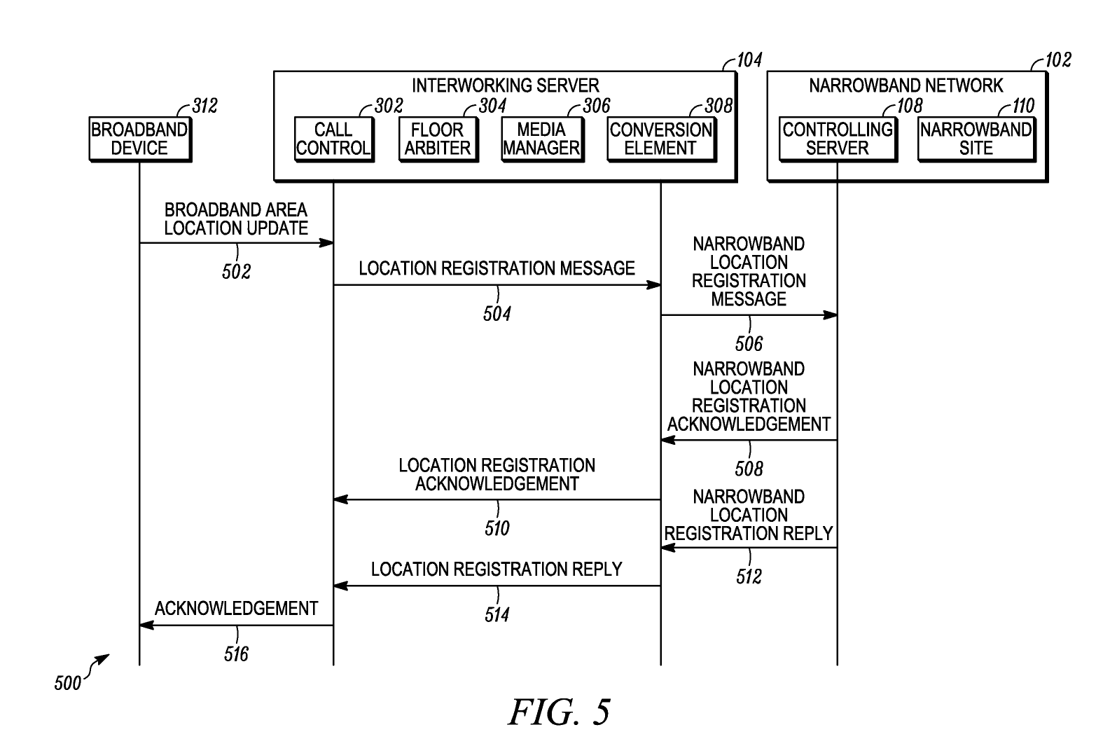

Further in accordance with 202, a first broadband device (operatively) coupled to the broadband network 106 is associated with a first virtual narrowband site (of the at least one virtual narrowband sites managed by the interworking server 104). As such, a broadband device may be associated with a given virtual narrowband site a priori. However, in accordance with embodiments of the present disclosure, the interworking server 104 associates (i.e., stores an association or mapping of) a given broadband device with a given virtual narrowband site depending on one or more factors. These factors include, but are not limited to: whether the broadband network and the broadband device are point-to-multipoint-enabled (e.g., MBMS-enabled); the location of the broadband device within the broadband network (e.g., with respect to FIG. 4, a broadband device is associated (upon sending a service activation request) with a virtual site mapped to the MBSFN area in which the broadband device is located); the location of the broadband device within the broadband network 106 relative to other broadband devices participating in a same narrowband communication group; the number of narrowband communication groups associated with a particular virtual narrowband site, etc. Moreover, the interworking server 104 may appropriately change the association of a broadband device from one virtual site to a different virtual site, for example, in accordance with embodiments described herein by reference to FIGS. 5 and 13.

At 204, the interworking server 104 exchanges signaling with the controlling server 108 to enable communications by the first broadband device using a first set of broadband resources corresponding to a first virtual narrowband channel of the first virtual narrowband site. The first virtual narrowband channel is assigned by the controlling server 108 for use by a first virtual narrowband device which represents (i.e., symbolizes) the first broadband device. More particularly, in accordance with the teachings herein, a broadband device coupled to the broadband network 106 is represented by a virtual narrowband device when data identifying a virtual narrowband device is associated with one or more corresponding broadband device identifiers in a relationship or mapping stored on the interworking server 104.

In one example implementation, the first virtual narrowband device represents the first broadband device using a narrowband device identifier, which is compatible with IDs used in the narrowband network to identify actual narrowband devices. The mapping between a narrowband device identifier and a broadband device identifier may by one-to-one. However, in an alternative implementation, multiple broadband device identifiers are mapped to a single narrowband device identifier. A narrowband device identifier comprises, for example, a P25-compatible subscriber unit identifier (SUID), a unit identifier, or some other form or combination of such identifiers.

In accordance with embodiments of the teachings herein (e.g., by reference to FIGS. 2-14), signaling between the interworking server 104 and the controlling server 108 contains at least one narrowband device identifier for a virtual narrowband device that represents a corresponding broadband device coupled to the broadband network 106. Whereas, signaling between the interworking server 104 and the broadband network 106 or a broadband device coupled to the broadband network 106 contains a broadband device identifier for the broadband device.

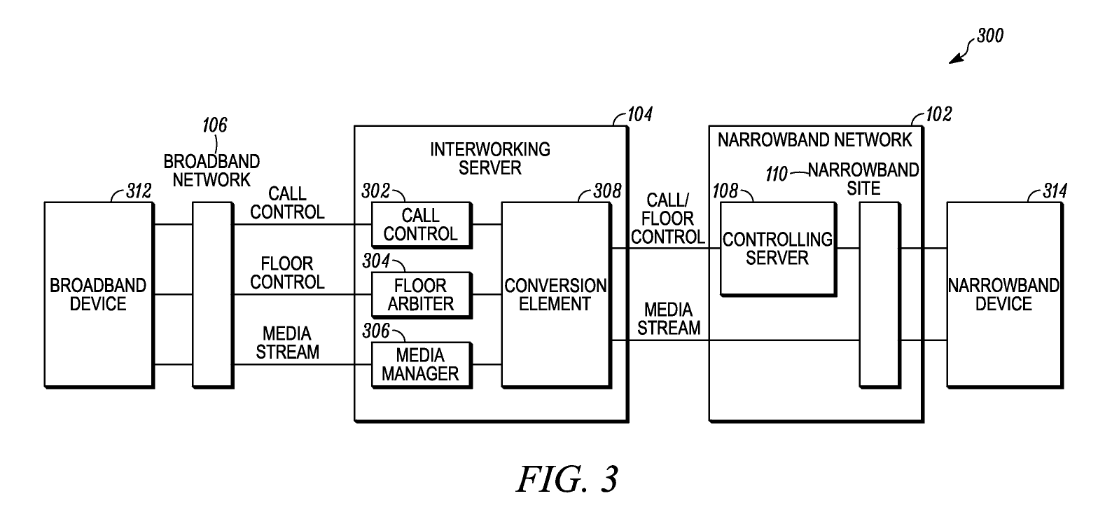

In one embodiment, the interworking server 104 (e.g., using an internal conversion element 308 (FIG. 3)) performs broadband-to-narrowband device identifier conversion, or vice versa, depending on the direction of the signaling. Such a conversion includes, for example, a simple reformatting between a narrowband network supported device identifier format and a broadband network supported device identifier format. Alternatively, the broadband device is identified within the broadband network 106 using a narrowband device identifier (i.e., the broadband device identifier is the same as the narrowband device identifier). In such a case, the “conversion” is simply forwarding the device identifier within the messages.

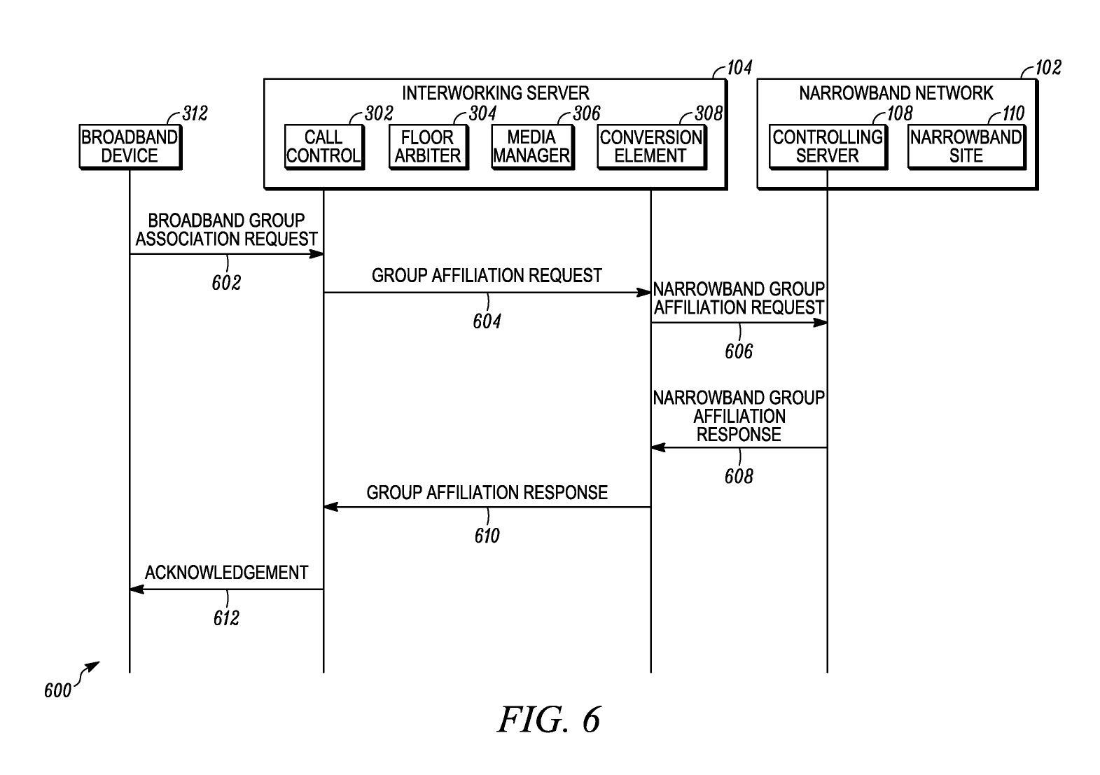

Similarly, the interworking server 104 (e.g., using an internal conversion element 308 (FIG. 3)) may perform a conversion (e.g., reformatting, etc.) between a broadband group identifier and a corresponding narrowband group identifier (and vice versa), when the messaging received by and sent from the interworking server 104 necessitates the inclusion of a communication group identifier (e.g., messaging of FIG. 6). Alternatively, the broadband group identifier and the corresponding narrowband group identifier are the same, and the “conversion” simply comprises forwarding the group identifier within the messages.

Moreover, in accordance with the teachings herein, the controlling server 108 is provisioned, e.g., a priori, with at least the IDs for one or more virtual narrowband devices and the IDs for a plurality of virtual narrowband channels for one or more virtual narrowband sites. Thus, during operation, the interworking server 104 provides to the controlling server 108: the ID for a given virtual narrowband device and the virtual narrowband site where the virtual narrowband device is located (which is the virtual narrowband site to which the corresponding broadband device is associated). Using this information, the controlling server 108 manages what it perceives to be narrowband channels for use in an active communication session (i.e., a call), by narrowband devices at the particular narrowband sites. In managing the virtual narrowband channels, the controlling server 108 effectively manages (directly and/or indirectly via the interworking server 104) broadband resources for use by broadband devices coupled to the broadband network 106.

In a particular example, the interworking server 104 provides to the controlling server 108 (e.g., during unit or location registration procedures as described below with reference to FIG. 4 and FIG. 5 respectively) an ID for the first virtual narrowband device, and identifies (e.g., using a site ID) the first virtual narrowband site, within which the first virtual narrowband device is purportedly “located.” Upon receiving notification that the virtual narrowband device is ready to communicate (e.g., during initiation of group communication for a narrowband group that the virtual narrowband device has joined or floor request procedures for the virtual narrowband device), the controlling server 108 selects a first virtual narrowband channel (of the plurality of virtual narrowband channels) of the first virtual narrowband site, for use by the first virtual narrowband device.

Thereafter, exchanging signaling (204) comprises the interworking server 104: receiving from the controlling server 108 an indication of the assignment of the first virtual narrowband channel; and determining the first set of broadband resources corresponding to the selected first virtual narrowband channel. In an embodiment, the indication of the assignment of the first virtual narrowband channel is received in a narrowband call grant message, which in one embodiment conforms to a format described in the P25 standards.

Where the broadband network 106 and the first broadband device are point-to-multipoint-enabled, determining the first set of broadband resources comprises selecting a first point-to-multipoint bearer. In one implementation, the point-to-point bearer is pre-allocated and mapped to the first virtual narrowband channel. Alternatively, the interworking server 104 communicates with the broadband network 106 to dynamically obtain the point-to-multipoint bearer and then maps the bearer to the first virtual narrowband channel.

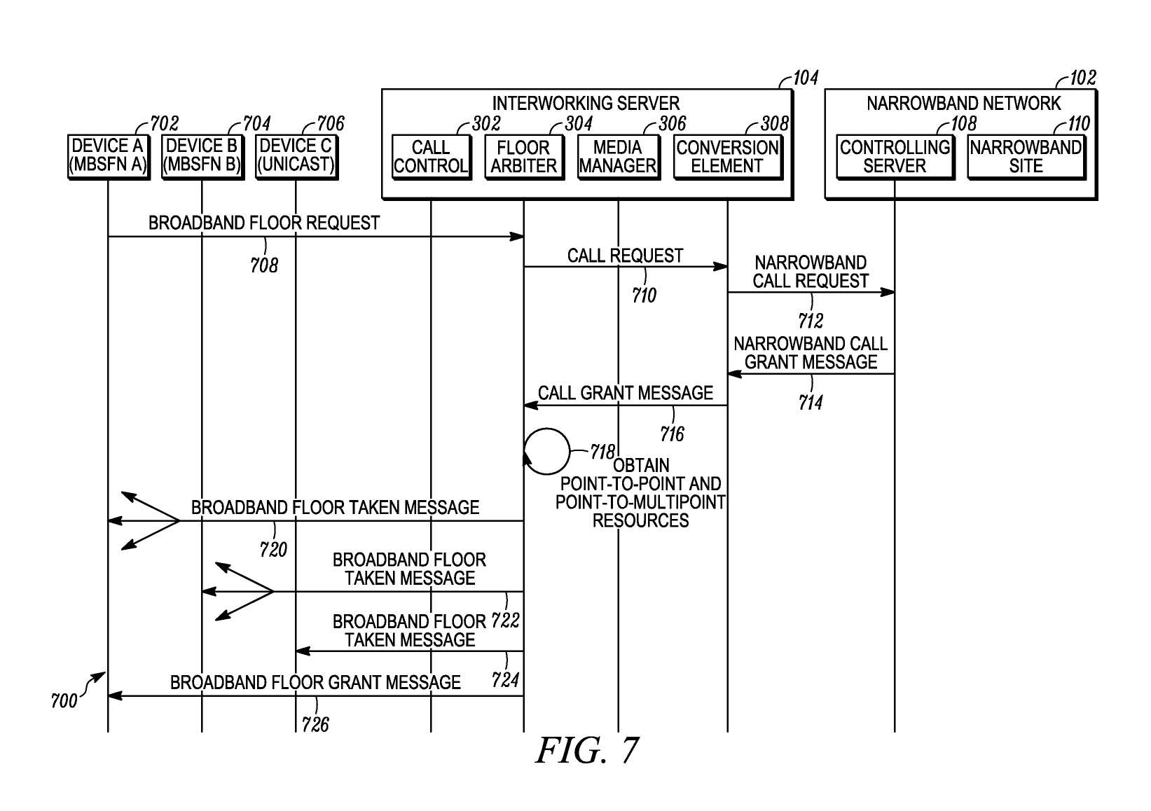

In one example implementation, when the broadband network 106 and the first broadband device are MBMS-enabled, the first point-to-multipoint bearer comprises a MBMS bearer of a plurality of MBMS bearers pre-allocated from a first MBSFN area of the broadcast network, wherein the plurality of MBMS bearers is mapped to the plurality of virtual narrowband channels for the first virtual narrowband site. Alternatively, the MBMS bearers are not pre-allocated.

Where the broadband network 106 or the first broadband device is not point-to-multipoint enabled, determining the first set of broadband resources can comprise the interworking server 104 signaling the broadband network 106 to allocate (i.e. obtain) a point-to-point bearer (as described below by reference to FIG. 7, and which may include procedures that conform to the LTE TSs), and mapping the obtained (or allocated) point-to-point bearer to the first virtual narrowband channel. Where multiple point-to-point bearers are needed for multiple broadband devices belonging to the same virtual narrowband site, they may all be mapped to the same virtual narrowband channel once obtained. As mentioned above, pre-allocated point-to-point bearers can also be used. In such a case, the interworking server 104 determining the first set of broadband resources comprises selecting the point-to-point bearer that is already mapped to the first virtual narrowband channel.

During communications, the interworking server 104 receives a first media stream and converts the first media stream to a second media stream for distribution to a communication group comprising at least the first virtual narrowband device. Reception, conversion and distribution of media streams occurs in multiple directions. For example, receiving the first media stream from the narrowband network 102, converting the first media stream to a second media stream which is compatible with the broadband network 106, and sending the second media stream to the first broadband device represents the flow of media from the narrowband network 102 (e.g., from a narrowband device) to a broadband device.

Receiving the first media stream from the first broadband device, converting the first media stream to the second media stream, which is compatible with the narrowband network 102, and sending the second media stream to the narrowband network 102 for distribution represents the flow of media from a broadband device to the narrowband network 102 (e.g., to one or more narrowband devices coupled the narrowband network 102). In an embodiment consistent with these teachings, a media stream received from the first broadband device may also be sent to other broadband devices coupled to the broadband network 106.

FIG. 3 is a block diagram of a communication system 300 that illustrates the passing and conversion of signaling between the broadband network 106 and the narrowband network 102 consistent with an embodiment of the present teachings. The elements shown for system 300 include: the interworking server 104, the controlling server 108 and the narrowband site 110 of the narrowband network 102, a narrowband device 314 coupled to the narrowband network 102, the broadband network 106, and a broadband device 312 coupled to the broadband network 106. Narrowband and broadband devices comprise devices commonly referred to in the art as mobile devices, access devices, access terminals, mobile stations, mobile subscriber units, subscriber units, user devices, client devices, and the like, which can be any type of communication devices, such as radios, mobile phones, mobile data terminals, Personal Digital Assistants (PDAs), laptops, two-way radios, cell phones, etc.

More particularly, FIG. 3 shows the interworking server 104 comprising a call control element 302, a floor arbiter element 304, a media manager element 306, and a conversion element 308; the first three elements also referred to herein as “call control,” “floor arbiter,” and “media manager,” respectively. These elements, and the internal messaging that takes place between them, support some of the functionality of the interworking server 104 described herein. The call control element 302, for example, processes requests received from the broadband network 106, generates internal messages for the conversion element 308, determines which sites communication groups are associated with, and validates successful completion of registrations.

Functionality performed by the floor arbiter 304 includes, but is not limited to: receiving and handling floor requests from broadband devices; generating internal messages for the conversion element 308; determining sites associated with a communication group; obtaining broadband resources or instructing call control 302 to do so; informing the media manager 306 of the obtained broadband resources; and starting and stopping media distribution. The media manager 306 receives media from a communication device holding the floor during a communication session (which can include a console device during a console takeover) and distributes the media to the other communication devices participating in that session. The participating devices may include both narrowband and broadband devices or only broadband devices participating in a narrowband communication group. In a particular embodiment where a console device has taken over the floor, the media manager 306 continues to receive media from the communication device that has lost the floor to the console. The media manager 306 sends that media to the narrowband network 102 while media from the console is distributed to the communication devices participating in the communication session.

A communication device holding the floor sends out media as a media stream. As used herein, a “media stream” can have both a media and a control component. For example, a media stream can comprise media packets that conform to a specific protocol and contain video or voice data while also comprising control signaling that is not part of the media proper. The media stream, however, does not have to be multiplexed in this way and may contain only media. The term “media packets” refers to media within the media stream that has been discretized into finite data units for transmission or storage, from which the media may be reconstructed through the use of a decoder.

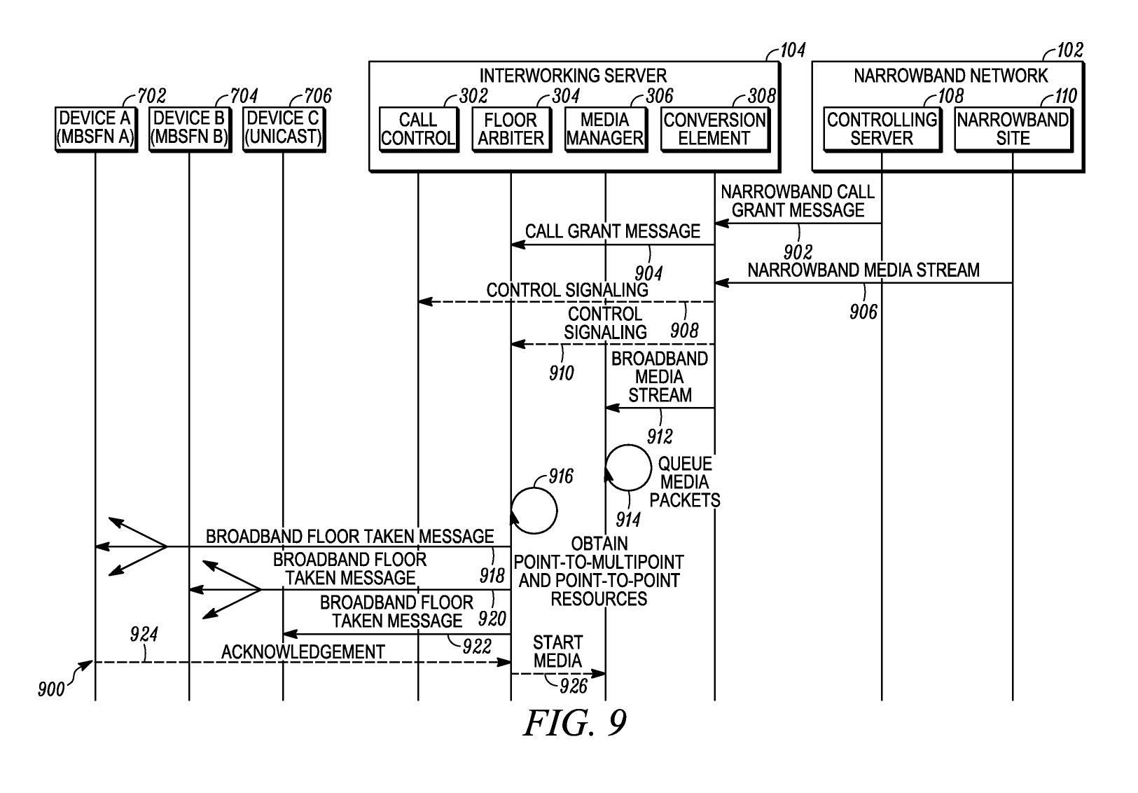

For a media stream received at the conversion element 308 from a narrowband device 314 located at and coupled to the narrowband site 110, one of the functions of the conversion element 308 is to de-multiplex the signals within the stream. Signaling within the media stream might be intended for the call control 302 or floor arbiter 304 elements while the media itself is meant for communication devices. The conversion element 308 separates the media from the control signals and generates a new media stream that is sent to the media manager 306 for distribution (e.g., FIG. 9 at 906 and 912). Generation of the new media stream could also involve reformatting or transcoding the media packets to make it suitable for broadband distribution. The conversion element 308 also generates separate control signals and sends each to its proper destination (e.g., FIG. 9 at 906-910).

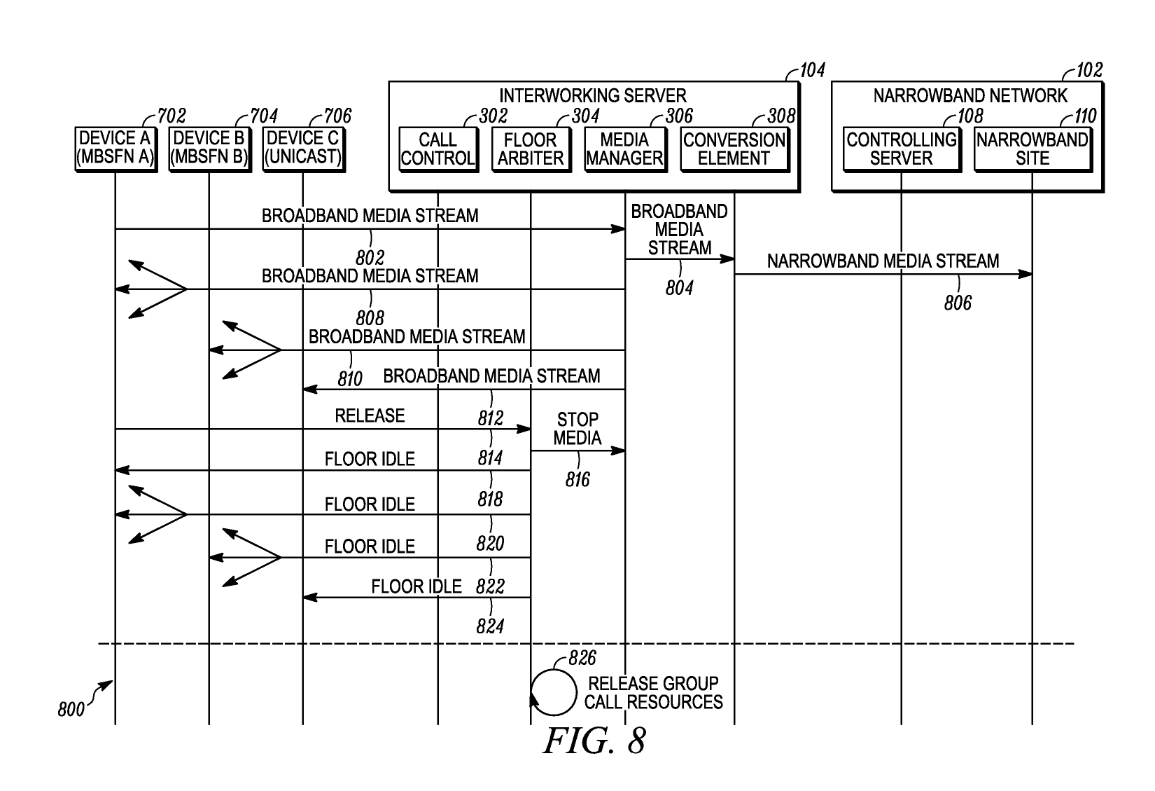

Alternatively, the conversion element 308 might multiplex or combine additional control information with media to generate a media stream. For example, the conversion element 308 might add control signaling to a broadband media stream received from a broadband device 312 via the media manager 306 before generating a corresponding narrowband media stream and sending it to the appropriate narrowband site 110 (e.g., FIG. 8 at 802-806). By contrast, the broadband media stream sent to the other broadband devices does not contain the added control signaling (e.g., FIG. 8 at 802, 808-812). In this way, control signaling can be included within or removed from media streams being sent in either direction, i.e., from the narrowband to the broadband network, and vice versa.

The conversion element 308 performs additional functionality in that it “converts” messages, meaning that it generates messages that are compatible with their intended destinations. For example, the interworking server 104 “converting” a message comprises the interworking server 104 generating a second message in response to a first message that it receives. This includes formatting generated messages and adhering to the protocols that are observed by the multiple elements that comprise communication system 300 as a whole. Several differing protocols and formats may be used for the aforementioned communication system, as indicated below. Thus, the conversion may or may not involve converting a format of the first message to a different format to generate the second message.

It is also consistent with an embodiment of the present teachings that a message “generated” by the conversion element 308 is identical to the message it received. In other words, the conversion element 308 may “convert” a message simply by forwarding the message without making any change to the content or format of that message. The message sequence diagrams shown in FIGS. 4-10 illustrate the interworking server 104 “converting” messages being sent between the broadband network or broadband devices and the narrowband network or narrowband devices.

As a further illustrative example, the conversion element 308 within the interworking server 104 receives a single combined call/floor control message from the controlling server 108. The call control signaling is then split off from the received transmission, and two messages are generated, one for call control 302, and one for floor control 304, each being compatible with the broadband network 106. In the opposite direction, call control and floor control signals from the broadband network 106 might be combined by the conversion element 308 into a single call/floor control message that is suitable for the controlling server 108. In an alternate embodiment, the narrowband network 102 sends separate call control and floor control messages to the interworking server 104 using different interfaces.

FIGS. 4-10 provide further examples of the interworking server 104 exchanging signaling (204) with the controlling server 108 within the narrowband network 102 to enable communications by one or more broadband devices, such as the one shown at 312 (e.g., the first broadband device), which are operatively coupled to the broadband network 106. The signaling indicated in FIGS. 4-10 can comprise a variety of protocols, which might include, for example, a suitable proprietary or standard session management protocol, such as Session Initiation Protocol (SIP) as defined in Internet Engineering Task Force (IETF) Request for Comments (RFC) 3261 dated June 2022.

For example, the interworking server 104 might exchange various standard SIP messages with the broadband network 106 and/or broadband devices to facilitate the present teachings as described herein. The SIP messages include, but are not limited to a SIP INVITE, a SIP MESSAGE, a SIP PUBLISH, a SIP NOTIFY, a SIP SUBSCRIBE, a SIP REGISTER, a SIP ACK, a SIP OPTIONS, a SIP PRACK, a SIP REFER, a SIP UPDATE, a SIP INFO, a SIP BYE, a SIP CANCEL, etc. As an illustrative example, the broadband group association request 602 referenced in FIG. 6 may be sent using a SIP INVITE, a SIP MESSAGE, or a SIP PUBLISH message. Similarly, the interworking server 104 might exchange signaling with the narrowband network 102 without any modification to the signaling that the controlling server 108 processes with respect to actual narrowband devices and narrowband sites. This obviates the need to modify elements within the narrowband network 102 or the narrowband devices.

Additional examples of control signaling protocols that may be used include: Serial Line Internet Protocol (SLIP), as defined in IETF RFC 1055 dated June 1988; Point-to-Point Protocol (PPP), as defined in IETF RFC 1968 dated June 1996; Binary Floor Control Protocol (BFCP), as defined in IETF RFC 4582 dated November 2006; or some variations thereof. Talk Burst Control Protocol (TBCP), Media Burst Control Protocol (MBCP), or any other protocol compatible with the Open Mobile Alliance (OMA) suite of standards for Push-to-talk over Cellular (PoC) are also a viable option.

Signaling involving media transport might involve a proprietary protocol or a standardized protocol, such as Real-time Transport Protocol (RTP), as defined in IETF RFC 3550 dated July 2003, or User Datagram Protocol (UDP), as defined by IETF RFC 786 dated August 1980, for example. In an embodiment, signaling internal to the interworking server 104 comprises proprietary signaling, but is not necessarily limited as such. The preceding list is not exhaustive, and additional protocols, standard or proprietary, may be used in differing combinations for signaling to and from the interworking server 104 from the broadband and narrowband networks and communication devices coupled to those networks.

For example, in accordance with a message sequence diagram 400 illustrated in FIG. 4, exchanging signaling comprises: receiving a service activation request for the first broadband device (e.g., 312); converting the service activation request to a narrowband device registration message; and sending the narrowband device registration message to the controlling server 108 to indicate a request for registration of the first virtual narrowband device to the narrowband network 102. In FIG. 4, signaling is exchanged between the broadband device 312, the interworking server 104 elements and the controlling server 108.

The term “unit registration,” as used herein, refers to a process by which a narrowband communication device becomes associated with (i.e., registered to) a particular narrowband network to which the narrowband device is coupled (via a particular narrowband site). Thus, unit registration (as illustrated by FIG. 4) registers a narrowband device to a narrowband network. “Location registration” (as illustrated by FIG. 5) identifies the narrowband site to which the narrowband device is coupled or, in other words, identifies the narrowband site where the narrowband device is located.

In accordance with the present teachings, narrowband unit and location registration processes are applied to register a virtual narrowband device to a narrowband network and to associate the virtual narrowband device with particular virtual narrowband site. In one embodiment, P25 unit registration and location registration procedures are implemented, including the signaling that is used in the case of actual narrowband networks, sites, and devices. However, any narrowband unit and location registration procedures could be used.

In particular, FIG. 4 shows the broadband device 312 sending a service activation request 402 to the call control element 302. Such a service activation request might be sent automatically when the broadband device 312 is powered up and registered with the broadband network 106, using any suitable broadband registration process, or sent at a later time, perhaps in response to user input entered into the broadband device 312. Included with the service activation request 402 may be particular service settings that define certain parameters regarding service for the broadband device 312. The call control element 302 receives the service activation request 402, records the particular service settings, and responds by sending an optional acknowledgement 404 back to the originating broadband device 312. Alternatively, call control 302 can send the optional acknowledgement 404 after receiving a device registration response 412.

After receiving the service activation request 402, the call control element 302 determines whether a narrowband (e.g., P25) unit registration procedure should be performed for the broadband device 312, e.g., by determining whether there is a corresponding narrowband device identifier mapped to the broadband device 312. If the narrowband unit registration procedure should be performed, call control 302 generates and sends an internal device registration request 406 to the conversion element 308. The conversion element responsively generates a narrowband device registration request 408, which it sends to the controlling server 108.

The resulting request 408 includes the narrowband device identifier that uniquely identifies a virtual narrowband device to the controlling server 108, wherein the narrowband device identifier represents the broadband device 312. In an embodiment, as a result of the service activation procedure, the interworking server 104 determines and maps a virtual narrowband site to the broadband device 312. Upon receipt of the narrowband registration request 408, the controlling server 108 processes the request 408, as it would such a request for an actual narrowband device, and sends a narrowband device registration response 410 back to the conversion element 308. The conversion element 308, in turn, generates and transmits an internal device registration response 412 back to the call control element 302.

In a particular embodiment, the broadband device 312 might withdraw from service upon powering down, or in response to user input. The broadband device 312, for example, might send a deactivation request (not shown) containing a broadband device identifier to call control 302, which then passes an internal message to the conversion element 308. The conversion element 308 then generates a device deregistration message and sends it to the controlling server 108 for processing in accordance with appropriate standard or proprietary protocols. The controlling server 108 then sends a narrowband device deregistration response back to the conversion element 308, which, in turn, generates an internal device deregistration response and sends it back to the call control element 302.

Turning now to FIG. 5, illustrated therein is a message sequence diagram 500 showing signaling between the broadband device 312, the interworking server 104 and the controlling server 108 used to perform a broadband area location update and corresponding narrowband (e.g., P25) location registration, in accordance with an embodiment of the present teachings. For example, where a first virtual narrowband site (e.g., to which broadband device 312 is associated) is mapped to a first broadband area, exchanging signaling (204) between the interworking server 104 and the controlling server 108 comprises the interworking server 104: receiving an indication that a first broadband device 312 has moved to a second broadband area that is mapped to a second virtual narrowband site; changing the association of the first broadband device 312 from the first virtual narrowband site to the second virtual narrowband site; and sending a narrowband location registration message to the controlling server 108 indicating that the first virtual narrowband device has changed location (i.e., has “moved” or changed location) from the first virtual narrowband site to the second virtual narrowband site.

In a particular embodiment consistent with illustrative system 100, the first broadband area comprises a first MBSFN area of the broadband network, and the second broadband area comprises a second MBSFN area of the broadband network. Moreover, the “movement” or change/indication of “location” of the virtual narrowband device is a logical movement or location affected within the interworking server 104 but is perceived by the controlling server 108 as a movement of an actual narrowband device between actual narrowband sites.

An event, that causes the interworking server 104 to update the controlling server 108 with the virtual narrowband site to which a particular broadband device/virtual narrowband device pair is associated is referred to herein as a mobility event. In one implementation scenario, the mobility event comprises a broadband device moving from one broadband area (e.g., MBSFN C 126) to another broadband area (e.g., MBSFN B 124), thereby resulting in the association of the broadband device and corresponding virtual narrowband device changing from a first virtual site (e.g., C 118) to a different virtual site (e.g., B 116). Alternatively, the mobility event comprises the broadband device 312 powering up and registering with the broadband system. In a corresponding embodiment, an initial location registration for the broadband device 312 is done concurrently with the device registration when the unit powers up, using combined signaling (e.g., adding broadband area and/or virtual narrowband site information to at least some of the signaling shown in FIG. 4). Alternatively, the initial location registration takes place separately from device registration, and signaling is exchanged separately for each process.

More particularly, with respect to FIG. 5, upon the occurrence of a mobility event for the broadband device 312, it sends a broadband area location update 502 that is received by the call control element 302. The broadband area location update 502 includes a broadband area ID (e.g., an MBSFN ID) that indicates the current position of the broadband device 312 with respect to the MBSFN areas that comprise the broadband network 106. The call control element 302 stores information included in the broadband area location update 502, and in so doing, records the association of the broadband device 312 with the identified MBSFN area. The interworking server 104 also passes an internal location registration message 504 from the call control element 302 to the conversion element 308 with the MBSFN ID from message 502 and with the broadband device 312 ID.

The conversion element 308 determines the virtual narrowband site to which the broadband device 312 is associated (in this case the virtual narrowband site mapped to the MBSFN ID) and determines the corresponding virtual narrowband device ID for broadband device 312. Conversion element 308 then generates a narrowband location registration message 506 having the determined virtual narrowband device ID and also indicating the determined virtual narrowband site to which the identified virtual narrowband device is currently associated. Conversion element 308 sends the narrowband location registration message 506 (also referred to as a mobility message) to the controlling server 108 to process.

While processing the mobility message 506, the controlling server 108 optionally sends a narrowband location registration acknowledgment (ACK) 508 that is received at the conversion element 308, as a notification that the controlling server 108 is processing mobility message 506. Responsive to ACK 508, conversion element 308 generates and passes a location registration acknowledgement 510 with the broadband device 312 ID to the call control element 302 as an internal message. ACKs 508 and 510 operate to suspend mobility message retry timers.

When the narrowband location registration message 506 processing is complete, the virtual narrowband device (corresponding to the broadband device 312) is associated, by the controlling server 108, to the virtual site that is mapped to the MBSFN ID identified in the message 502. If the location registration process is being performed concurrently with unit registration, then the location registration procedure provides the initial indication of the virtual site where the virtual narrowband device is located. Alternatively, if the virtual narrowband device was previously successfully registered to the narrowband network 102, then its virtual site location is updated.

In addition, the controlling server 108 sends a narrowband location registration reply 512 for the virtual narrowband device that is received at the conversion element 308. Upon receiving the reply 512, the conversion element 308 generates an internal location registration reply 514 identifying the broadband device 312, which is forwarded to the call control element 302. In turn, the call control element 302 may send an optional acknowledgement 516 to the broadband device 312 signaling that its location update is completed.

Shown in FIG. 6 is a message sequence diagram 600 that illustrates the exchange of signaling between the broadband device 312, the interworking server 104 and the controlling server 108 to enable the broadband device 312 to participate in a session or call for a particular narrowband communication group, in accordance with an embodiment of the present disclosure. In accordance with FIG. 6, exchanging signaling (204) between the interworking server 104 and the controlling server 108 comprises the interworking server 104: receiving a broadband group association request, for the first broadband device, which identifies a first narrowband communication group; converting the broadband group association request to a narrowband group affiliation request; and sending the narrowband group affiliation request to the controlling server 108 for joining the first virtual narrowband device to the first narrowband communication group.

In general, when the user of the broadband device 312 wishes to participate in a communication session involving a particular narrowband communication group managed by the narrowband network 102, he uses his broadband device 312 to trigger, with the controlling server 108, a narrowband affiliation procedure (e.g., a P25 conforming procedure) to affiliate (also referred to herein as “join”) the corresponding virtual narrowband device to the narrowband group. As a result, the controlling server 108 signals the virtual narrowband device (and the interworking server signals the broadband device 312) when the narrowband group is active; and the controlling server 108 properly routes media for the narrowband group to the interworking server 104, which is forwarded to the broadband device 312.

With greater particularity, FIG. 6 shows the broadband device 312 sending a broadband group association request 602 that is received at the call control element 302. The request 602 contains a broadband and/or narrowband identifiers for the broadband device 312 and the communication group for which session participation is desired. Upon determining that the identified communication group is among those managed by the narrowband network 102, call control 302 passes an internal group affiliation request 604 to the conversion element 308, which identifies the communication group. Request 604 triggers the conversion element 308 to generate a narrowband group affiliation request 606 that identifies the virtual narrowband device (corresponding to the broadband device 312) and contains the ID for the narrowband communication group. If needed, prior to generating the request 606, the conversion element 308 performs a broadband to narrowband group identifier conversion to obtain the narrowband group ID, which is inserted into the request 606. Conversion element 308 sends the request 606 to the controlling server 108.

The controlling server 108 processes the request 606 to join the virtual narrowband device to the identified narrowband group (as it would for such a request received from an actual narrowband device), which effectively joins the broadband device 312 to the identified narrowband group. Joining, as used herein, is the process by which the controlling server 108 and/or the interworking server 104 associates (or affiliates, in the case of a talkgroup) a uniquely identified communication device with a uniquely identified communication group so that the communication device is authorized to participate in an active communication session or call involving the communication group.

Upon completing the processing for request 606, the controlling server 108 transmits a narrowband group affiliation response 608 identifying the virtual narrowband device mapped to the broadband device 312 and identifying the narrowband communication group, which is received at the conversion element 308. Responsively, the conversion element 308 generates and sends to call control 302 an internal group affiliation response 610, which identifies the broadband device 312 and the narrowband communication group. Upon receiving the response 610, call control 302 sends an acknowledgement 612 to the broadband device 312 signaling that it is successfully joined to the identified narrowband group in order to receive active communications for that group.

In a further embodiment, the broadband device 312 de-associates with the narrowband communication group. For example, message 602 is modified to become a broadband group de-association request, to indicate that the broadband device 312 is de-associating from the narrowband communication group, so as to no longer receive media for that group. In turn, messages 604 to 610 are modified to facilitate a narrowband de-affiliation process to de-affiliate the corresponding virtual narrowband device from the narrowband group. In one example implementation, such de-affiliation is accomplished by the controlling server 108 affiliating the virtual narrowband device with a “null” narrowband group, which simply serves as an indication that the particular virtual narrowband device is not affiliated with any narrowband group. Acknowledgement 612 can also be modified to indicate to the broadband device 312 the completion of the de-association procedure.

FIG. 7 is a message sequence diagram 700 illustrating a group communication session for a narrowband communication group being initiated by a broadband device A 702 in accordance with an embodiment of the present disclosure. The signaling shown in diagram 700 includes signaling between the interworking server 104 and broadband devices 702-706 and signaling between the interworking server 104 and the controlling server 108. Further in accordance with FIG. 7, exchanging signaling (204) comprises the interworking server 104: receiving a broadband floor request for the first broadband device 702; converting the broadband floor request 708 to a narrowband call request 712 for the first virtual narrowband device; and sending the narrowband call request 712 to the controlling server 108.

More particularly, a group member (in this case a user of the broadband device A 702) uses the device A 702 to initiate participation in a group call for a narrowband communication group. For example, the user presses a push-to-talk button on his broadband device 702, which causes the device to send (on an uplink bearer) a broadband floor request 708 identifying the narrowband communication group and the broadband device A 702 to the floor arbiter 304 (or to call control 302 in an alternate embodiment). Uplink bearers are generally point-to-point only, but the broadband floor request 708 is not precluded from being carried by other types of bearers where the broadband network 106 is so capable.

Upon determining that the identified communication group is a narrowband communication group (i.e., that the communication group is managed or “homed” on the narrowband network 102), the floor arbiter 304 defers floor arbitration decisions for this group to the narrowband network 102 by exchanging the requisite signaling with the controlling server 108. Accordingly, the floor arbiter 304 (e.g., using call control 302) identifies the current MBSFN (e.g., MBSFN A 122) and the current virtual narrowband site (e.g., in this case virtual site A 114, which is mapped to MBSFN A) associated with the broadband device A 702. The floor arbiter 304 (or call control 302 in the alternate embodiment) generates and sends an internal call request message 710 that includes this information to the conversion element 308. It should be noted that where a broadband device is not within a MBSFN area or is not MBMS-capable (such as with broadband device 706), the interworking server 104 may associate that broadband device to any virtual site corresponding to an MBSFN area, or to one specifically maintained for such devices.

Upon receiving message 710, conversion element 308 converts any broadband identifiers to narrowband identifiers and generates a narrowband group call request 712 (also referred to herein simply as a narrowband call request) identifying the narrowband communication group and the virtual narrowband device (corresponding to the broadband device A 702) which is sent to the controlling server 108 to proceed with the floor arbitration for the identified group. In this example implementation, the controlling server 108 responsively assigns the floor to the virtual narrowband device that represents the broadband device A 702 (as it would for an actual narrowband device) and, accordingly, sends a narrowband call grant message 714 that is received at the conversion element 308, indicating the floor assignment.

In this embodiment, the call grant message 714 identifies the virtual narrowband device (that represents the broadband device A 702) as having been assigned the floor and also includes a virtual narrowband channel assignment from the plurality of virtual narrowband channels mapped to the virtual site A 114. The controlling server 108 selects or assigns the virtual narrowband channel (of a virtual site) for the call. Where the controlling server 108 has received an indication that one or more virtual narrowband devices are located at the virtual site, it can be said that the selected virtual narrowband channel is “for use by” the virtual narrowband device(s) located at that virtual site. In another illustrative implementation, the controlling server 108 selects a virtual narrowband channel for a virtual site where no virtual narrowband devices are located at the virtual site. This implementation is practiced, for instance, where the controlling server is provided with information indicating that a virtual narrowband channel assignment for that virtual site should be performed for the calls of certain identified narrowband groups, regardless of whether a virtual narrowband device is located at the virtual site.

Responsive to the message 714, the conversion element 308 generates and sends to the floor arbiter 304 (or call control 302 in the alternate embodiment) a call grant message 716 indicating the floor assignment to the broadband device A 702 and the virtual narrowband channel assignment for virtual site A 114. The controlling server 108 sends out call grant messages 714 for each virtual site with available virtual narrowband channels that contains a participating group member device (which in this case includes the virtual narrowband sites to which the virtual narrowband devices corresponding to broadband devices B 704 and C 706 are joined). It should also be noted that the controlling server 108 sends narrowband call grant messages to any actual narrowband site having an actual narrowband device at that site which is participating in the call for the particular narrowband communication group.

Each additional call grant message 714 also contains a virtual narrowband channel assignment from the respective virtual site and identifies the virtual narrowband device corresponding to the broadband device A 702 as having been assigned the floor. In an embodiment, each narrowband call grant message 714 received causes the conversion element 308 to generate and send to the floor arbiter 304 a corresponding internal call grant message 716. Each message 716 indicates the selected virtual narrowband channel assignment for the respective virtual site, including each virtual site having an associated broadband device participating in the communication session for the narrowband communication group.

Upon receiving a first such call grant message 716 from the conversion element 308, the floor arbiter 304 notifies (not shown) the media manager 306 so that it begins to compile a distribution table for the call. Information stored in this table includes, for example, one or more narrowband multicast addresses (identified by the floor arbiter 304) that are used by the narrowband network 102 for the distribution of media to the one or more actual narrowband sites having actual narrowband devices joined to the call. Information stored in this table also identifies the broadband resources allocated for distributing media for the narrowband communication group to those broadband devices participating in the session for the group (e.g., devices 702-704). The floor arbiter 304 passes this information for the table to the media manager 306 upon determining or obtaining these broadband resources at 718.

Utilizing the call control element 302 (signaling not shown), the floor arbiter 304 prepares for the call/session by obtaining (718) the broadband resources needed to deliver the media to devices 702-706. These resources comprise point-to-point and/or point-to-multipoint bearers within the broadband network 106 that will be used by the broadband devices 702-706 participating in the group call. More specifically, for broadband device A 702, which is located in MBSFN A 122 and has access to point-to-multipoint bearers, the floor arbiter 304 obtains a resource by determining which pre-allocated, for example, point-to-multipoint (e.g., MBMS) bearer maps to the virtual narrowband channel selected by the controlling server 108 from the virtual narrowband site (corresponding to MBSFN A 122) to which broadband device A 702 is associated.

Likewise, the floor arbiter 304 determines a point-to-multipoint broadband bearer for broadband device B 704 located in MBSFN B 124. By contrast, broadband device C 706 does not have access to point-to-multipoint resources. In this case, a point-to-point downlink bearer is allocated and used to provide media to the device C 706. In this particular embodiment, where point-to-point broadband bearers are not pre-allocated for narrowband communication sessions, the interworking server 104 obtains any point-to-point resources as needed for the call by interacting with the broadband network 106 to establish them, and maps the obtained point-to-point resources to the selected virtual narrowband channel.

It might also be the case that broadband device C 706 resides within an MBSFN area with access to a pre-allocated point-to-multipoint bearer, but that it is the only, or one of few participating broadband devices located within the MBSFN area. For this scenario, intelligence within the interworking server 104 may determine, through the application of an algorithm, for example, that “lighting up” all the eNodeBs within the MBSFN area is an inefficient use of broadband resources. The interworking server 104, thus, instead elects to establish point-to-point bearers for certain broadband devices even where point-to-multipoint bearers are available.

When the broadband resources are obtained, in addition to informing (not shown) the media manager 306 of the acquired resources, the floor arbiter 304 also indicates to the participating broadband devices 702-706 that the floor has been assigned to device A 702. It does this by sending broadband floor taken messages 720-724 to all the broadband devices 702-706 participating in the narrowband group call. For devices A 702 and B 704, the broadband floor taken messages 720 and 722 are sent using the point-to-multipoint bearers obtained for the call. For device C 706, the floor arbiter 304 uses the established point-to-point bearer to deliver the broadband floor taken message 724. The floor arbiter 304 also sends a broadband floor grant message 726 to device A 702 using a point-to-point bearer, informing the device A 702 that it has the floor. The floor arbiter 304 may then signal (not shown) the media manager 306 to begin distributing media received from the broadband device (in this case device A 702) holding the floor.

FIG. 8 is a message sequence diagram 800 that illustrates the distribution of media in accordance with an embodiment of the present disclosure. More particularly, FIG. 8 shows the media manager 306 within the interworking server 104 receiving a broadband media stream 802 via a point-to-point uplink bearer from the broadband device A 702 (which was granted the floor, see, e.g., FIG. 7). The media manager 306 then forwards this broadband media stream (shown now as 804 but can be the same media stream as 802) to the conversion element 308, which generates a narrowband media stream 806, for instance as indicated above by reference to FIG. 3. Generation of the narrowband media stream 806 may involve reformatting of media packets to be compatible with distribution within the narrowband network, rebundling frames, decrypting media, etc.

The conversion element 308 sends the narrowband media stream 806 to the proper narrowband sites (e.g., the narrowband site 110) within the narrowband network 102 using the multicast address(es) supplied by the floor arbiter 304. The media manager 306 also forwards the broadband media stream using the broadband resources obtained (e.g., at 718), as shown by 808, 810, and 812 so that it is received by the other broadband devices 704, 706 participating in the group call.

When broadband device A 702 finishes sending its media stream 802 to the media manager 306, it uses the point-to-point bearer to send a release message 814 received at the floor arbiter 304 and indicating that it no longer requires the floor. The floor arbiter 304, in turn, sends a stop media message 816 to inform the media manager 306 to stop distributing media. The floor arbiter 304 also notifies the other broadband devices by sending floor idle messages 820-824 using the obtained broadband bearers. The floor arbiter 304 may also send the device A 702 a separate floor idle message 818 using a point-to-point bearer. In an alternate embodiment, no floor idle messages are sent to the broadband devices. Instead, the broadband resources sit idle for a predetermined amount of time or until another participating communication device requests the floor. If another broadband device is granted the floor and sources media, the sequence 802-824 repeats itself for that device, and the group call continues. Where no communication device responds before an inactivity timer reaches a preset limit, the floor arbiter 304 releases (826) the broadband group call resources, and the call is taken down.

In some embodiments, backup measures are used to ensure that the system does not continue to hold resources that are no longer needed. For example, if the floor arbiter 304 misses the release message 814, the obtained resources will not be freed for the next device to take the floor. To prevent this, the media manager 306 might report (not shown) to the floor arbiter 304 at regular intervals as media is received. If a report is not received from the media manager 306 for a given length of time, the floor is released automatically and made available to the other devices.

FIG. 9 is a message sequence diagram 900 illustrating control signaling and media exchanged between the narrowband network 102 and the interworking server 104, and also between the interworking server 104 and the broadband network 106 (FIG. 3) to which broadband devices 702-706 are operatively coupled, associated with a floor request originating in the narrowband network 102, in accordance with an embodiment of the present teachings. In this illustrative implementation, the signaling is shown to enable both narrowband devices (not shown) and broadband devices 702-706 to participate in a media exchange for the same narrowband communication group.

In a specific embodiment, the exchange of signaling comprises the interworking server 104: receiving a narrowband media stream comprising media packets from the narrowband network 102; storing a set of the media packets in a queue; and responsive to a trigger, sending the set of media packets from the queue to a first broadband device. For example, the trigger comprises one or more of: in response to sending a broadband floor taken message, receiving an acknowledgement from the first broadband device; a timer timing out, for instance by reaching a preset limit; a buffer reaching capacity (e.g., being full or reaching some capacity threshold); or a message generated internal to the interworking server 104.

More particularly, FIG. 9 shows the controlling server 108 sending a narrowband call grant message 902 that is received at the conversion element 308. A narrowband call grant message is sent to the conversion element 308, for example, when the controlling server 108 issues the floor to a narrowband device coupled to the narrowband network 102 (e.g. located on site 110) that is initiating a call. In an embodiment where multiple virtual narrowband devices (representing participating broadband devices) are located at different virtual narrowband sites, the controlling server sends multiple such messages 902, one for each site. In response to receiving the narrowband call grant message 902, the conversion element 308 generates an internal call grant message 904 and sends it to the floor arbiter 304.

After the narrowband call grant message 902 is sent, the narrowband device holding the floor (which in this illustrative embodiment is located at the narrowband site 110) transmits a narrowband media stream, which the conversion element 308 receives (906) from the narrowband site 310. The conversion element 308 processes the narrowband stream 906, for example, as indicated with reference to FIG. 3. In an embodiment, such processing comprises extracting control signaling from the narrowband stream 906. The conversion element 308 sends the extracted control signaling, if necessary, to call control 302 and/or the floor arbiter 304 at 908 and 910, respectively.

The conversion element 308 also generates a broadband media stream 912 (which may include a format conversion of media packets) and sends it to the media manager 306. The media manager stores (914) a set of media packets from the stream 912 in a queue for later delivery, e.g., after the necessary broadband resources are obtained. One or more identifiers embedded within the media stream 912 enable the media manager to identify the media packets as belonging to a particular narrowband communication group, in this case, the group to which the originator of the narrowband media stream 906 belongs.

While the media packets are being queued (914), and in response to receiving the call grant message 904, the floor arbiter 304 utilizes the call control element 302 (signaling not shown) to obtain (916) the broadband resources needed to deliver the buffered media stream to the broadband devices 702-706 participating in the group communication session, in a manner analogous to that indicated in FIG. 7 at 718. In an alternate embodiment, the floor arbiter 304 obtains at 916 (and also at 718) the broadband resources without enlisting the help of call control 302.

Using the obtained bearers, the floor arbiter 304 sends broadband floor taken messages 918-922 to broadband devices 702-706, and any other broadband devices participating in the communication session, to indicate that the floor is assigned to a particular narrowband device. The narrowband device is identified in the messages 918-922 by a broadband network-compatible device identifier that is generated by the conversion element 308 from a narrowband network-compatible device identifier received in the narrowband call grant message 902. Separate point-to-multipoint bearers are used to reach the participating devices A 702 and B 704 in MBSFN A 122 and MBSFN B 124, respectively. For broadband device C 706, a point-to-point bearer is used to send the broadband floor taken message 922 for the same reasons as described with respect to FIG. 7.

With the broadband bearers ready to deliver media, a trigger begins the transmission of the media packets queued at 914 to the broadband devices 702-706 participating in the communication session. Examples of events that might trigger the delivery of the buffered media stream include the interworking server 104 receiving an acknowledgement 924 from a first broadband device in response to sending a broadband floor taken message, and/or a trigger (e.g., a start media message 926) generated internal to the interworking server 104. The delivery of the buffered media stream might alternatively be triggered by the buffer nearing (based on some threshold) or reaching (as with a full buffer) its capacity to store media packets, or the passage of a predetermined amount time as measured by an inactivity timer located within the interworking server 104. Any other suitable trigger could also be used to begin the delivery of the queued media packets.

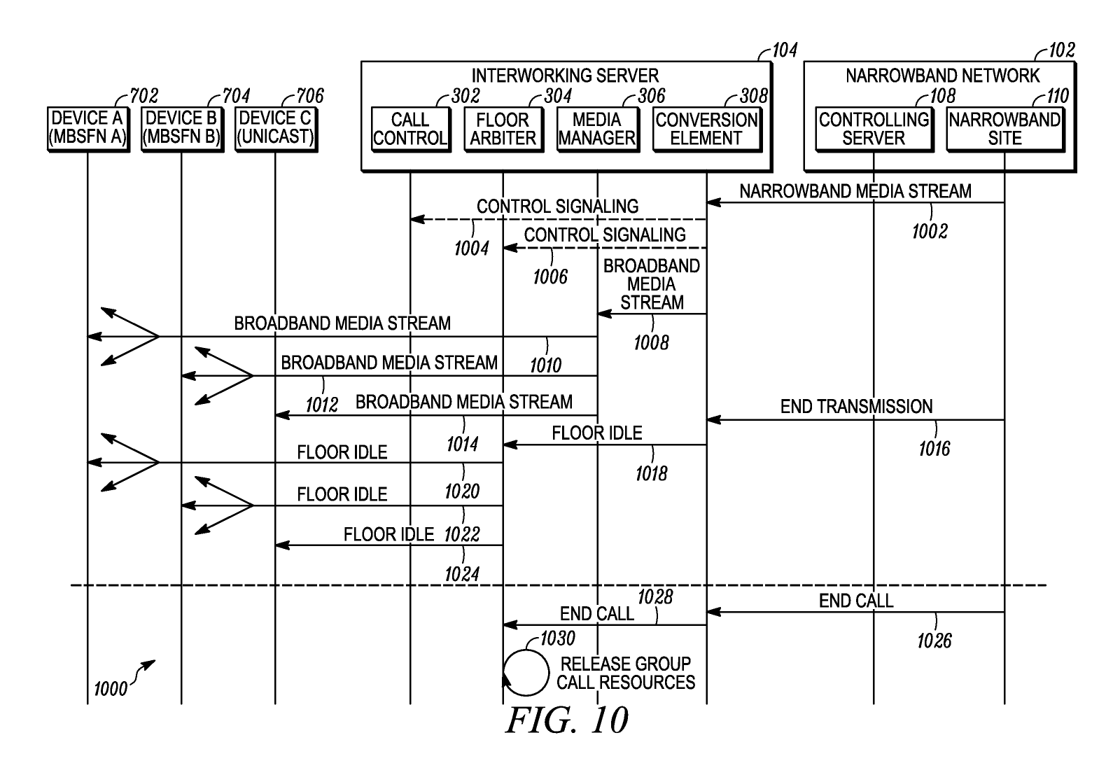

FIG. 10 is a message sequence diagram 1000 illustrating the distribution of media originating from the narrowband network 102 and the subsequent floor release in accordance with an embodiment of the present teachings. More particularly, FIG. 10 shows the conversion element 308 continuing to receive a narrowband media stream 1002 (continued from 906) from the narrowband site 110. In an example implementation, the media stream originates from a narrowband device (not shown) located at the narrowband site 110. As the media stream 1002 is being received, the conversion element 308 continues to strip away control signaling, which is forwarded to call control 302 and the floor arbiter 304, respectively, at 1004 and 1006 (continued from 908 and 910). Additionally, the conversion function 308 processes what remains of the media stream 1002 and generates a broadband media stream 1008, which it sends to the media manager 306 for delivery to the participating broadband devices 702-706, at 1010-1014 respectively. In an alternate embodiment, the controlling server 108 is also configured to distribute call control signaling, floor control signaling and media to a virtual narrowband site where no virtual narrowband devices are located. As indicated above with reference to FIG. 7, the controlling server 108 can be provided with information indicating that virtual narrowband channel assignment for such a virtual site should be performed for the calls of certain identified narrowband groups.

When the narrowband device finishes sending its media, it sends an end transmission message to relinquish the floor, which is received (1016) from the narrowband site 110 at the conversion element 308. The conversion element 308, in turn, generates a floor idle message 1018 and passes it to the floor arbiter 304, which uses the obtained broadband bearers to convey floor idle messages 1020-1024 to the participating broadband devices 702-706. The system now stands ready for a response from the next communication device to take the floor.

When the communication session is concluded, as might be indicated by the expiration of an activity timer located within the controlling server 108, the floor arbiter 304 releases (1030) the broadband resources, and the call is taken down. In the alternative, a narrowband device may proactively end the call by sending an end call message that is received (1026) from the narrowband site 110 at the conversion element 308. The conversion element 308, in turn, generates and sends an end call message 1028 to the floor arbiter 304. Upon receiving the message 1028, the floor arbiter 304 releases (1030) the broadband resources, and the call is taken down. In an alternate embodiment, the end transmission message 1016 and/or the end call message 1026 are relayed through the controlling server 108 before being received by the conversion element 308.

FIG. 11 shows the communication system indicated in FIG. 1 with additional virtual narrowband sites managed by the interworking server 104 (and thereby labeled as system 1100), in accordance with another embodiment of the present teachings. It is noted that, for the sake of brevity, descriptive language for identical elements within the two drawings is not repeated here. In this example implementation, a plurality of virtual sites is mapped to each of the MBSFN areas 122, 124 and 126. More particularly, FIG. 11 shows an interworking server 104 managing three virtual sites, namely sites A₁ 1102, A₂ 1104 and A₃ 1106, mapped to MBSFN A 122; two virtual sites, namely sites B₁ 1108 and B₂ 1110, mapped to MBSFN B 124; and three virtual sites, namely sites C₁ 1112, C₂ 1114 and C₃ 1116, mapped to MBSFN C 126.

A virtual site construct such as the one illustrated in FIG. 11 is beneficial in a system, wherein the narrowband network has certain limitations. For example, many actual narrowband sites support only a limited number of actual narrowband channels, as a consequence of the equipment used at the narrowband sites. Therefore, to properly mimic these narrowband sites to the controlling server 108, the virtual sites are created with the same limitations to the number of its corresponding virtual narrowband channels. This limits the number of narrowband group calls that can be supported in the broadband system (because it limits the number of virtual narrowband channels that are available to the controlling server 108 for assigning to calls), even where the underlying broadband network 106 has the resource capacity to support additional narrowband calls.

For example, a virtual site might be constructed (due to the limitations of the narrowband network) to support only a maximum of n virtual narrowband channels and corresponding narrowband group calls. Whereas, an MBSFN area within the broadband network 106 mapped to that virtual site might comprise 3n point-to-multipoint bearers that can be allocated for use to support narrowband group communications; or many more point-to-point bearers than n may be assignable for use for such communications. This restriction is overcome by associating additional virtual sites to serve the same MBSFN area. For the example described above, the restriction is overcome by mapping three virtual sites to the MBSFN area, each supporting n virtual narrowband channels managed by the controlling server 108. Alternatively, one or more of the virtual sites may support n number of point-to-point bearers, for instance where at least some areas within the broadband network 106 (or the network as a whole) are not point-to-multipoint capable.

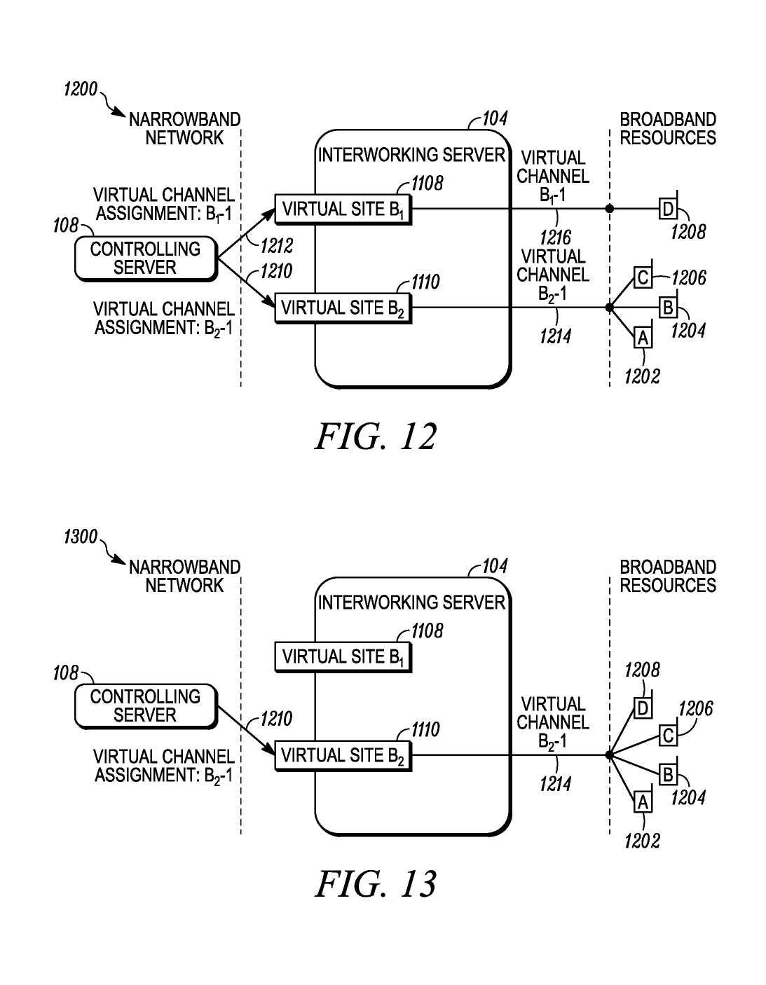

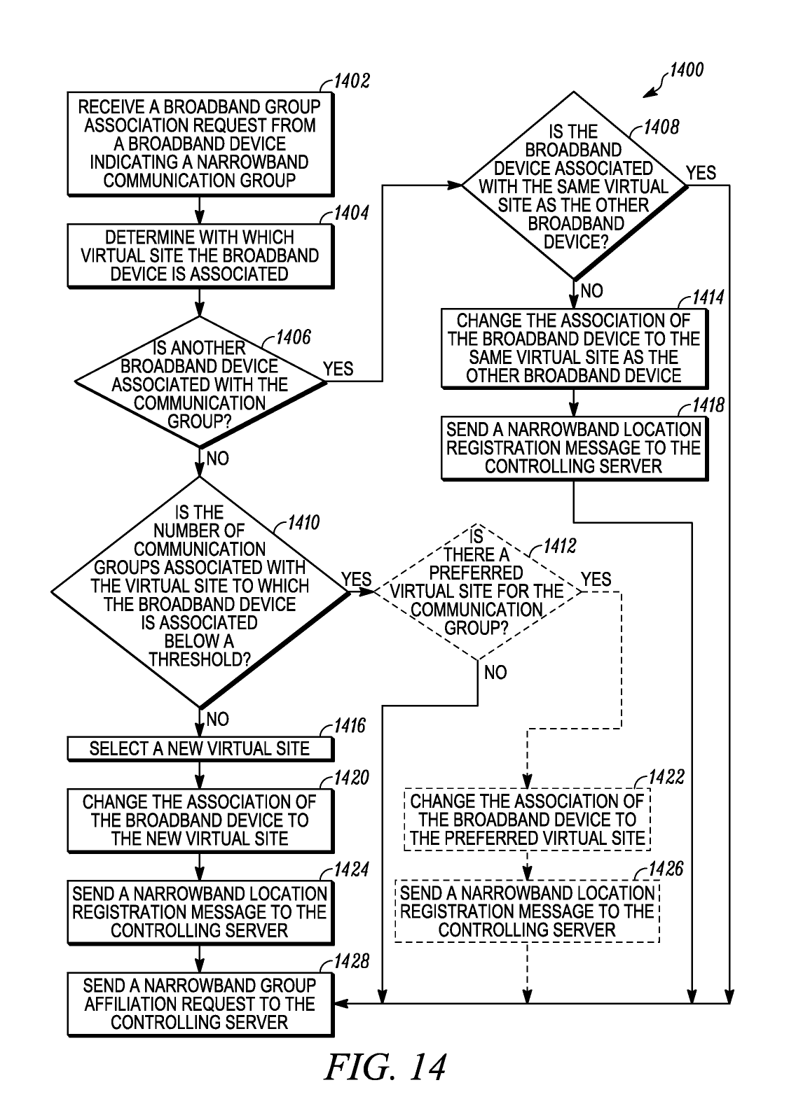

While creating multiple virtual sites to serve single MBSFN areas in this way does allow the controlling server 108 to successfully manage a larger number of broadband resources, other complications are introduced, which are addressed by the disclosed embodiment described by reference to FIG. 14. For instance, FIG. 12 illustrates a drawback associated with distributing broadband devices belonging to (i.e., participating in the communications of) the same narrowband communication group over different virtual narrowband sites. More particularly, FIG. 12 shows an example system implementation 1200 with four point-to-multipoint-capable broadband devices: A 1202, B 1204, C 1206 and D 1208. Moreover, each device is physically located within MBSFN B 124, and all belong to the same narrowband communication group.

At the controlling server 108, devices 1202-1206 are associated with virtual site B₂ 1110, and device 1208 is associated with virtual site B₁ 1108. Accordingly, to include all four devices 1202-1208 in an active communication session involving the narrowband group, the controlling server 108 needs to assign (1210, 1212) two virtual narrowband channels: channel B₂-1 1214 for the narrowband group communications to reach devices 1202-1206, and an additional channel B₁-1 1216 for the narrowband group communications to reach device 1208. This unnecessarily uses virtual narrowband channel capacity that could be used to support a different narrowband group call.

FIG. 13 illustrates an outcome of applying the present teachings as illustrated by a method 1400 described in detail below with respect to FIG. 14. For example, a specific embodiment consistent with method 1400 involves the interworking server 104: determining that a second virtual narrowband device that represents a second broadband device is joined to a first narrowband communication group and that the second broadband device is associated with a second virtual narrowband site; changing the association of a first broadband device from a first virtual narrowband site to the second virtual narrowband site; and sending a narrowband location registration message to the controlling server 108 indicating that the first virtual narrowband device has changed location (i.e., has moved) from the first virtual narrowband site to the second virtual narrowband site.

As shown by reference to an illustrative system implementation 1300 (FIG. 13), using the method 1400 results in all the broadband devices 1202-1208 belonging to the same narrowband communication group being associated with a single virtual site 1110, such that the controlling server 108 only assigns (1210) the virtual narrowband channel B₂-1 1214 to support the narrowband group call. This is accomplished by the interworking server 104 performing a location registration that removes the association of broadband device 1208 with virtual site B₁ 1108 and replaces it with an association to virtual site B₂ 1110.

In accordance with another embodiment consistent with method 1400, the load placed on multiple virtual narrowband sites serving an MBSFN area is distributed across those sites as the number of narrowband communication groups grows for which broadband devices in the MBSFN area are participating devices. An illustrative procedure for load balancing in accordance with the present teachings involves the interworking server 104: receiving a broadband group association request, for a first broadband device, which identifies a first narrowband communication group; determining that associating a first narrowband communication group with a first virtual narrowband site would cause a total number of narrowband communication groups associated with the first virtual narrowband site to exceed a threshold number; changing the association of the first broadband device from the first virtual narrowband site to a second virtual narrowband site; and sending a narrowband location registration message to the controlling server 108 indicating that the first virtual narrowband device has changed location from the first virtual narrowband site to the second virtual narrowband site.

In accordance with another embodiment consistent with method 1400, is a procedure for associating a broadband device with a preferred virtual site. One example implementation involves the interworking server 104: receiving a broadband group association request, for a first broadband device, which identifies a first narrowband communication group; determining that no other virtual broadband narrowband devices are joined to the first narrowband communication group; determining that a second virtual narrowband site is a preferred site for the first narrowband communication group; changing an association of the first broadband device from the first virtual narrowband site to the second virtual narrowband site; and sending a narrowband location registration message to the controlling server 108 indicating that the first virtual narrowband device has changed location from the first virtual narrowband site to the second virtual narrowband site.

Turning now to the details of the method 1400, FIG. 14 illustrates one possible algorithm employed by the interworking server 104 to associate broadband devices to virtual narrowband sites, consistent with the teachings herein. More particularly, the interworking server 104 receives (1402) from a broadband device, via a suitable broadband interface, a broadband group association request (e.g., 602, FIG. 6) indicating a narrowband communication group. Logic within the interworking server 104 determines (1404) with which virtual narrowband site the broadband device is associated. In one example implementation, the broadband device is associated with a particular virtual narrowband site during an initial location registration procedure (e.g., FIG. 5).

The interworking server 104 also determines (1406) if another broadband device is already associated with (i.e., joined to) the same narrowband communication group. Where another broadband device is associated with the same narrowband communication group, the interworking server 104 further queries (1408) if both broadband devices are associated with the same virtual site. If they are, the interworking server 104 proceeds to send (1428) a narrowband group affiliation request to the controlling server 108 to join the corresponding virtual narrowband device (for the broadband device) to the indicated narrowband communication group (see, e.g., 606, FIG. 6).

If they are not, the interworking server 104 associates (1414) the broadband device submitting the group association request to the virtual site of the other broadband device and sends (1418) a narrowband location registration message to the controlling server 108 (e.g., 506, FIG. 5). The narrowband location registration message identifies this new virtual narrowband site. The interworking server 104 also sends (1428) a narrowband group affiliation request to the controlling server 108 that identifies the new virtual site and the narrowband communication group. The affiliation request may be sent together with the location registration message, or the location registration message may be sent first.

If, at 1406, the interworking server 104 determines that there is no other broadband device associated with the narrowband communication group indicated at 1402, it proceeds to determine (1410) if the number of groups already associated with the virtual narrowband site to which the broadband device is associated exceeds a threshold number. The threshold may be set by a system administrator and/or be determined dynamically by an algorithm. For example, the threshold for a site might be set at eighty percent of the maximum number of virtual narrowband channels the site supports until alternate sites are so populated, at which time the threshold increases incrementally with those of the alternate sites until its limit is reached.

Where the threshold is exceeded, the interworking server 104 selects (1416) an alternate virtual narrowband site, associates (1420) the broadband device with the alternate virtual narrowband site and sends (1424) a location registration message to indicate to the controlling server 108 that the virtual narrowband device (corresponding to the broadband device) has moved to a new (i.e., the alternate) virtual narrowband site. The interworking server 104 then sends (1428) a narrowband group affiliation request to the controlling server 108 that identifies the new virtual narrowband site and the narrowband communication group.

Where the interworking server 104 determines (1410) that the number of communication groups associated with the virtual narrowband site to which the broadband device is associated is below the threshold amount, it may simply send (1428) a narrowband group affiliation request to the controlling server 108 for the identified narrowband communication group. Alternatively, and optionally, the interworking server 104 determines (1412) if there is a preferred site for the narrowband communication group identified at 1402.

A preferred site can comprise particular attributes other sites do not, e.g., attributes that allow the communication group to function most efficiently for its intended purpose. For example, a virtual narrowband site that supports particular codecs might serve as the preferred site for groups that require high bit-rate processing. In one embodiment, all police groups are placed on a preferred site reserved for police groups; while fire-fighting groups are placed on a preferred site for all such groups. In another embodiment, a virtual narrowband site with a given number of virtual narrowband channels is the preferred site for a small number of critical groups. By hosting only these critical groups, resource availability is always guaranteed.

If no preferred site exists, the interworking server 104 sends (1428) the narrowband group affiliation request to the controlling server 108, as described before. If a preferred site does exist, the interworking server 104 changes (1422) the association of the broadband device to the preferred virtual site and sends (1426) a narrowband location registration message to the controlling server 108. The interworking server 104 also sends (1428) a narrowband group affiliation request to the controlling server 108 which may be delivered together with the location registration or after the location registration is complete.

While not shown, other algorithms that comprise different operations performed in alternate orders from that indicated above are also possible. In one example implementation, the determination (1412) of whether there is a preferred site for the communication group indicated at 1402 occurs before the determination (1410) is made as to whether the association of an additional narrowband communication group with a virtual site would cause a threshold to be exceeded. In an alternative illustrative implementation, the determination (1412) of a preferred site is absent from the algorithm altogether.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an interworking server for enabling interoperability between a broadband network and a narrowband network, the method comprising:
maintaining at least one virtual narrowband site, each comprising a plurality of virtual narrowband channels known by a controlling server within the narrowband network, wherein each virtual narrowband channel, when assigned by the controlling server, represents a corresponding set of broadband resources, wherein a first broadband device coupled to the broadband network is associated with a first virtual narrowband site; and
exchanging signaling with the controlling server to enable communications by the first broadband device using a first set of broadband resources corresponding to a first virtual narrowband channel of the first virtual narrowband site, wherein the first virtual narrowband channel is assigned by the controlling server for use by a first virtual narrowband device which represents the first broadband device.

2. The method of claim 1 further comprising:
receiving a first media stream;
converting the first media stream to a second media stream for distribution to a communication group comprising at least the first virtual narrowband device;
wherein the receiving, converting and distribution further comprises one of:
receiving the first media stream from the narrowband network, converting the first media stream to the second media stream which is compatible with the broadband network, and sending the second media stream to the first broadband device; or
receiving the first media stream from the first broadband device, converting the first media stream to the second media stream, which is compatible with the narrowband network, and sending the second media stream to the narrowband network for distribution.

3. The method of claim 1, wherein exchanging signaling comprises:
receiving a service activation request for the first broadband device;
converting the service activation request to a narrowband device registration message; and
sending the narrowband device registration message to the controlling server to indicate a request for registration of the first virtual narrowband device to the narrowband network.

4. The method of claim 1, wherein the first virtual narrowband device represents the first broadband device using a narrowband device identifier.

5. The method of claim 1, wherein exchanging signaling comprises:
receiving a broadband floor request for the first broadband device;
converting the broadband floor request to a narrowband call request for the first virtual narrowband device; and
sending the narrowband call request to the controlling server.

6. The method of claim 1, wherein exchanging signaling comprises:
receiving from the controlling server an indication of the assignment of the first virtual narrowband channel; and
determining the first set of broadband resources corresponding to the first virtual narrowband channel.

7. The method of claim 6, wherein determining the first set of broadband resources comprises selecting a first point-to-multipoint bearer.

8. The method of claim 7, wherein the first point-to-multipoint bearer comprises a first pre-allocated Multimedia Broadcast/Multicast Service (MBMS) bearer of a plurality of MBMS bearers from a first Multi-Media Broadcast over a Single Frequency Network area of the broadcast network, wherein the plurality of MBMS bearers is mapped to the plurality of virtual narrowband channels for the first virtual narrowband site.

9. The method of claim 6, wherein determining the first set of broadband resources comprises signaling the broadband network to allocate a point-to-point bearer, and mapping the allocated point-to-point bearer to the first virtual narrowband channel.

10. The method of 6, wherein the indication of the assignment of the first virtual narrowband channel is received in a narrowband call grant message.

11. The method of claim 1, wherein exchanging signaling comprises:
receiving a narrowband media stream comprising media packets from the narrowband network;
storing a set of the media packets in a queue; and
responsive to a trigger, sending the set of media packets from the queue to the first broadband device.

12. The method of claim 11, wherein the trigger comprises at least one of:
in response to sending a broadband floor taken message, receiving an acknowledgement from the first broadband device;
a timer timing out;
a buffer reaching capacity; or
a message generated internal to the interworking server.

13. The method of claim 1, wherein the first virtual narrowband site is mapped to a first broadband area, and wherein exchanging signaling comprises:
receiving an indication that the first broadband device has moved to a second broadband area that is mapped to a second virtual narrowband site;
changing the association of the first broadband device from the first virtual narrowband site to the second virtual narrowband site; and
sending a narrowband location registration message to the controlling server indicating that the first virtual narrowband device has changed location from the first virtual narrowband site to the second virtual narrowband site.

14. The method of claim 13, wherein the first broadband area comprises a first Multimedia Broadcast over a Single Frequency Network (MBSFN) area of the broadband network, and the second broadband area comprises a second MBSFN area of the broadband network.

15. The method of claim 1, wherein exchanging signaling comprises:
receiving a broadband group association request, for the first broadband device, which identifies a first narrowband communication group;
converting the broadband group association request to a narrowband group affiliation request; and
sending the narrowband group affiliation request to the controlling server for joining the first virtual narrowband device to the first narrowband communication group.

16. The method of claim 15 further comprising:
determining that a second virtual narrowband device that represents a second broadband device is joined to the first narrowband communication group and that the second broadband device is associated with a second virtual narrowband site;
changing the association of the first broadband device from the first virtual narrowband site to the second virtual narrowband site; and
sending a narrowband location registration message to the controlling server indicating that the first virtual narrowband device has changed location from the first virtual narrowband site to the second virtual narrowband site.

17. The method of claim 15 further comprising:
determining that associating the first narrowband communication group with the first virtual narrowband site would cause a total number of narrowband communication groups associated with the first virtual narrowband site to exceed a threshold number;
changing the association of the first broadband device from the first virtual narrowband site to a second virtual narrowband site; and
sending a narrowband location registration message to the controlling server indicating that the first virtual narrowband device has changed location from the first virtual narrowband site to the second virtual narrowband site.

18. The method of claim 15 further comprising:
determining that no other virtual narrowband devices are joined to the first narrowband communication group;
determining that a second virtual narrowband site is a preferred site for the first narrowband communication group;
changing an association of the first broadband device from the first virtual narrowband site to the second virtual narrowband site; and
sending a narrowband location registration message to the controlling server indicating that the first virtual narrowband device has changed location from the first virtual narrowband site to the second virtual narrowband site.

19. An apparatus for enabling interoperability between a broadband network and a narrowband network, the apparatus comprising:
a processing device configured to maintain a set of virtual narrowband sites, each virtual narrowband site comprising a plurality of virtual narrowband channels known by a controlling server within the narrowband network;
a first interface configured to receive from the controlling server an assignment of a first virtual narrowband channel from the plurality of virtual narrowband channels of a first virtual narrowband site of the set of virtual narrowband sites, wherein the assignment is for a first group communication session for a first narrowband communication group to which a first virtual narrowband device is joined, wherein the first virtual narrowband device represents a first broadband device coupled to the broadband network and is associated with the first virtual narrowband site, wherein the processing device is further configured to determine a first broadband resource corresponding to the first virtual narrowband channel; and
a second interface configured to provide to the first broadband device an indication of the first broadband resource for the first broadband device to at least one of send or receive a media stream for the first group communication session.

20. A non-transient computer-readable storage element having computer-readable code stored thereon for programming a computer to perform a method for enabling interoperability between a broadband network and a narrowband network, the method comprising:
maintaining at least one virtual narrowband site, each comprising a plurality of virtual narrowband channels known by a controlling server within the narrowband network, wherein each virtual narrowband channel, when assigned by the controlling server, represents a corresponding set of broadband resources, wherein a first broadband device coupled to the broadband network is associated with a first virtual narrowband site; and
exchanging signaling with the controlling server to enable communications by the first broadband device using a first set of broadband resources corresponding to a first virtual narrowband channel of the first virtual narrowband site, wherein the first virtual narrowband channel is assigned by the controlling server for use by a first virtual narrowband device which represents the first broadband device.
